(19) United States
(12) Patent Application Publication
(10) Pub. No.: US 2026/0241374 A1
(43) Pub. Date: Aug. 20, 2026

(54) COMPOSITIONS AND METHODS FOR MITIGATING AGGREGATION OF AND RECYCLING OF NANOSCALE CATALYSTS

(71) Applicant: Massachusetts Institute of Technology, Cambridge, MA (US)

(72) Inventors: Julia Ortony, Cambridge, MA (US); Yukio Cho, Cambridge, MA (US); Kiera Y. Tai, Cary, NC (US)

(73) Assignee: Massachusetts Institute of Technology, Cambridge, MA (US)

(21) Appl. No.: 18/992,892

(22) PCT Filed: Aug. 18, 2023
(86) PCT No.: PCT/US2023/030589

§ 371 Date: Jan. 9, 2025

(51) Int. Cl. B01J 31/06; B01J 35/45; B01J 35/55; B01J 37/04; B01J 38/48; B01J 38/72

(52) U.S. Cl. CPC B01J 31/062; B01J 35/45; B01J 35/55; B01J 37/04; B01J 38/48; B01J 38/72

(57) ABSTRACT

What is described herein are nanostructures, compositions comprising the nanostructures, and related methods. In some embodiments, the nanostructure comprises an aramid amphiphile and a functional moiety associated with the aramid amphiphile. In some cases, the functional moiety may be configured to perform catalysis. According to some embodiments, a nanostructure comprising an aramid amphiphile, comprising a cysteine charged group; and a functional moiety selected from the group consisting of a nanoparticle, an enzyme, and a metal complex; wherein the functional moiety is bound to the aramid amphiphile through the cysteine is described. Also disclosed are uses of the nanostructures as catalysts in chemical reactions.

### RELATED APPLICATIONS

This application claims priority under 35 U.S.C. § 119(e) to U.S. Provisional Patent Application No. 63/373,051, filed Aug. 20, 2022, and entitled “METHOD FOR MITIGATING AGGREGATION OF AND RECYCLING OF NANOSCALE CATALYSTS,” which is incorporated herein by reference in its entirety for all purposes.

### TECHNICAL FIELD

Compositions and methods for mitigating aggregation of and recycling of nanoscale catalysts are generally described.

### BACKGROUND

Catalysts in an aqueous system can generally be classified into one of two types: (1) homogeneous catalysts, which are essentially uniformly distributed in the solution with the reactants and products; and (2) heterogeneous catalysts, which typically exist as solid (e.g., undissolved and/or unsuspended particles and/or other solids) and not in the solution phase. These two classes have benefits and limitations. For example, heterogeneous catalysts are more commonly used in industry because they can be designed for use as a continuous system, but their catalytic activities are generally lower/slower than homogeneous catalysts. Homogeneous catalysts, such as molecular catalysts and solution-distributed metal nanoparticle catalysts, typically exhibit high reaction activities, but can be difficult to separate from solution once the catalysts are fully dissolved or distributed in a solution. This may lead to the waste of the catalysts after performing homogeneous catalysis in solution. Accordingly, improved compositions and methods are needed.

### SUMMARY

Compositions and methods for mitigating aggregation of and recycling of nanoscale catalysts are generally described. The subject matter of the present disclosure involves, in some cases, interrelated products, alternative solutions to a particular problem, and/or a plurality of different uses of one or more systems and/or articles.

Some aspects are related to nanostructures.

In some cases, the nanostructure comprises an aramid amphiphile and a functional moiety associated with the aramid amphiphile, wherein the functional moiety is configured to catalyze a chemical reaction. In some embodiments, the functional moiety of the nanostructure is chemically bound to the aramid amphiphile. In some embodiments, the functional moiety of the nanostructure is covalently bound to the aramid amphiphile. In some embodiments, the functional moiety of the nanostructure comprises a nanoparticle, an enzyme, and/or a metal complex. In some embodiments, the functional moiety of the nanostructure is selected from the group consisting of a nanoparticle, an enzyme, and a metal complex. In some embodiments, the aramid amphiphile of the nanostructure comprises a cysteine group. In some embodiments, the cysteine group of the nanostructure is charged. In some embodiments, the cysteine group of the nanostructure is chemically bonded to the functional moiety. In some embodiments, the aramid amphiphile of the nanostructure comprises an amino acid, amino acid derivative, and/or peptide.

In some embodiments, the nanostructure comprises a plurality of aramid amphiphiles. In some embodiments, the plurality of aramid amphiphiles of the nanostructure is arranged as a nanoribbon and/or a nanotube. In some embodiments, the plurality of aramid amphiphiles of the nanostructure is self-assembled as a nanoribbon and/or a nanotube. In some embodiments, the nanoribbon and/or the nanotube of the nanostructure have an aspect ratio of at least 1:25.

In some embodiments, the nanostructure comprises a plurality of functional moieties, wherein each of the functional moieties is covalently bound to at least one aramid amphiphile of the plurality of aramid amphiphiles. In some embodiments, the functional moieties of the nanostructure are present in an amount of greater than or equal to 100 moieties per nanostructure. In some embodiments, functional moiety is configured to catalyze a chemical reaction, wherein the chemical reaction is a reduction or oxidation reaction, comprises proton reduction, comprises oxygen reduction and/or comprises dehydrogenating a reactant.

Some aspects are related to compositions.

In some embodiments, the composition comprises a solution or suspension, any of the preceding nanostructures in the solution or suspension, and a reactant in the solution or suspension, wherein the functional moiety of the nanostructures is configured to homogeneously catalyze the reactant to a product.

Still other aspects are related to methods.

In some embodiments, methods of making any of the preceding nanostructures are described. In some cases, the method comprises providing a first solution or suspension comprising the aramid amphiphile of the nanostructure, and mixing the first solution or suspension with a second solution or suspension comprising the functional moiety of the nanostructure.

In some embodiments, methods of using any of the preceding nanostructures are described. In some embodiments, the method comprises providing the nanostructure in a solution or suspension, and catalyzing, with the nanostructure, a conversion of a reactant to a product in the solution or suspension.

According to some embodiments, the method comprises converting a reactant to a product in a solution or suspension, the solution or suspension comprising the nanostructure, and separating the nanostructure from the solution or suspension. In some embodiments, the method further comprises rinsing the nanostructure in an aqueous solution. In some embodiments, the solution or suspension of the method is a first solution or suspension, further comprising resuspending the separated nanostructure in a second solution or suspension comprising the reactant. In some embodiments, the method further comprises repeating the method using the second solution or suspension. In some embodiments, separating the nanostructure from the solution or suspension comprises passing the solution or suspension through a membrane. In some embodiments, separating the nanostructure from the solution or suspension comprises passing the solution or suspension through a filter. In some embodiments, the filter comprises a syringe filter. In some embodiments, the chemical reaction comprises a reduction or oxidation reaction, comprises proton reduction comprises oxygen reduction, and/or comprises dehydrogenation of a reactant.

One aspect of the disclosure herein is a nanostructure comprising an aramid amphiphile comprising a charged cysteine group, a functional moiety selected from the group consisting of a nanoparticle, an enzyme, and a metal complex, wherein the functional moiety is covalently bound to the aramid amphiphile through the cysteine. In some embodiments of the nanostructure, the nanostructure comprises the structure of Cys AA. In some embodiments of the nanostructure, the functional moiety is a nanoparticle. In some embodiments, the nanoparticle comprises gold or TiO₂. In some embodiments of the nanostructure, the functional moiety is a metal complex. In some embodiments, the metal complex comprises protoporphyrin IX or bipyridine. In some embodiments of the nanostructure, the aramid amphiphile is self-assembled into a nanotube. In some embodiments of the nanostructure, the aramid amphiphile is self-assembled into a nanoribbon. In some embodiments, the nanostructure comprises a multiplicity of functional moieties.

One aspect is a method of use of the nanostructure disclosed to catalyze a chemical reaction, comprising preparing a reactant, combining the reactant with the nanostructure in a solution, converting the reactant to a product in the solution, separating the nanostructure from the solution, and restoring the catalytic activity of the nanostructure by rinsing in an aqueous solution water. In some embodiments of the method of use, the nanostructure is used in a multiplicity of successive chemical reactions.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic illustration of a nanostructure, according to some embodiments;

FIG. 2 is a flow diagram of an example method, according to some embodiments;

FIG. 3 is a schematic illustration of functionalizing aramid amphiphile (AA) self-assembled nanostructures with gold nanoparticles, wherein the assemblies can be used as nano-reactors to catalyze the reaction in aqueous environment, according to some embodiments;

FIGS. 4A-4D show representative transmission electron microscope images of gold nanoparticles functionalized AA self-assembled nanostructures, wherein the size of gold nanoparticles is (A) 10 nm, (B) 5 nm, and (C-D) 1.8 nm, with (D) representing fully loaded nanostructures, according to some embodiments;

FIG. 5A show that homogeneously distributed gold nanoparticles functionalized AA self-assembled nanostructures in solution can be separated by commercial syringe filter, with accompanying UV-vis spectra showing the solution before and after passing through the filter, according to some embodiments;

FIG. 5B is a plot of gold concentration in a filtrate solution as a function of filtration cycle, according to some embodiments;

FIG. 5C shows a size distribution plot of CysAA nanostructures, according to some embodiments;

FIG. 6A-6C show plots relating to the catalytic activity of nanostructures, according to some embodiments;

FIG. 7 is a schematic illustration showing a synthesis scheme to obtain the aramid amphiphile with cysteine amino acid surface chemistry compound, according to some embodiments;

FIG. 8 is a schematic illustration of various AA nanoribbons functionalized by metal complexes, nanoparticles, and enzymes with unique photosynthesis capabilities, according to some embodiments;

FIGS. 9A-9B show schematic illustrations of the self-assembly of aramid amphiphiles and subsequently functionalized, self-assembled structures, according to some embodiments;

FIG. 10A is a schematic diagram of various aramid amphiphiles, according to some embodiments;

FIG. 10B is an image of a self-assembled structure comprising an aramid amphiphile, according to some embodiments;

FIGS. 10C-10F are various plots of physical parameters of the self-assembled structures shown in FIG. 10B, according to some embodiments;

FIGS. 11A-11E are transmission electron microscope images of nanostructures, according to some embodiments;

FIG. 11F is a plot obtained from performing x-ray photoelectron spectroscopy of the nanostructures of FIGS. 11A-11E, according to some embodiments;

FIG. 12A is a schematic illustration of the filtering of nanostructures, according to some embodiments;

FIGS. 12B-D are plots of the catalytic activity of nanostructures, according to some embodiments; and

FIG. 13 are images showing solutions containing Au nanoparticles and nanostructures being filtered, according to some embodiments.

### DETAILED DESCRIPTION

Some aspects are related to nanostructures, for example, for performing catalysis or other applications. In some cases, the nanostructures include a self-assembled structure comprising aramid amphiphiles and a functional moiety associated with the aramid amphiphiles. The functional moiety, in some embodiments, may be a catalyst and/or configured to perform catalysis. Some aspects are related to compositions, for example, comprising the nanostructures. Still other aspects are related to methods, for example, of making and/or using the nanostructures and/or compositions, or the like.

Catalysts in an aqueous system can generally be classified into one of two types: (1) homogeneous catalysts, which are essentially uniformly distributed in the solution with the reactants and products; and (2) heterogeneous catalysts, which typically exist as solid (e.g., undissolved and/or unsuspended particles and/or other solids) and not in the solution phase. These two classes have benefits and limitations. For example, heterogeneous catalysts are more commonly used in industry because they can be designed for use as a continuous system, but their catalytic activities are generally lower/slower than homogeneous catalysts. Homogeneous catalysts, such as molecular catalysts and solution-distributed metal nanoparticle catalysts, typically exhibit high reaction activities, but can be difficult to separate from solution once the catalysts are fully dissolved or distributed in a solution. This may lead to the waste of the catalysts after performing homogeneous catalysis in solution. Accordingly, some aspects of the present disclosure are related to anchoring homogeneous catalysts to microscopic support materials to achieve better catalytic activity in solution than heterogeneous catalysts, while facilitating the separation and reusability of the homogeneous catalysts.

This disclosure includes forming nanostructures by anchoring of molecular catalysts and/or other functional moieties on the surface of the self-assembled structures to use such catalysts and/or functional moieties repeatedly. In some cases, some of the nanostructures may heretofore have been considered unconventional due to the ability to separate and reuse the catalysts and/or functional moieties of the nanostructures. The approaches described herein provide the ability to repeatedly utilize the strong catalytic performance of the functional moieties of the nanostructures, for example, compared to conventional heterogeneous catalysts with lower activities or single-use homogeneous catalysts. Additionally, considering the high performance of small metal nanoparticles (e.g., compared to bulk materials), the material cost of the relatively expensive materials (e.g., precious metals such as gold in one set of embodiments) is often proportional to weight. Therefore, by using small, highly active metal nanoparticles (e.g., less than or equal to 10 nm), improved performance and decreased cost of the catalysts (e.g., functional moieties, nanoparticles) can be achieved and can be utilized repeatedly, e.g., on a support structure such as the nanostructures described herein.

In some cases, the compositions, nanostructures, and methods described herein have various advantages and improvements over existing methods, devices, or materials. For example, previously used deposition-precipitation and co-precipitation methods are commonplace for depositing metal nanoparticles on the surface of metal oxide particles. The catalytic activity of such metal nanoparticle functionalized metal oxide particles is well understood by those of ordinary skill in the art. Generally, such conventional methods produce non-uniform distributions of metal nanoparticles on the surface, e.g., of a metal oxide particle substrate. Because the surface chemistry of the metal oxides is mostly fixed, the heterogeneous nucleation, e.g., from a tetrachloroaurate ion, selectively occurs on particular defects of the surface of the metal oxide particles and limits the loading ratio of metal nanoparticles on the surface and may limit catalytic activity. This prevents the particles from being distributed in the solution homogeneously and/or from forming with a uniform size. Additionally, the diameter of the metal oxide particles is relatively small, which limits the amount of available surface area on which the metal nanoparticles can form. Some other existing materials for supporting metal nanoparticles include carbon-based materials, glass, and polymeric materials, but these materials also have low surface chemistry tunability and/or low surface area, similar to metal oxide particles.

Alternatively, nanoscale structures with surface catalysts may be constructed by small molecule(s) self-assembly in water. Self-assembly occurs when small molecules form nanostructures to maximize favorable interactions with their liquid environments. In some cases, the nanostructures may have highly specific surface areas, precise spatial arrangements, and may be separatable from the solution due to the nanostructure's physical configuration (e.g., dimensions, orientation, etc.). Furthermore, catalytic properties of the nanostructure can be tuned by modifying the surface chemistry of the constituent molecules (e.g., the small molecules comprising the self-assembled structure). By tuning the surface chemistry, different catalysts may be anchor to the surface of the self-assembled structure. However, self-assembled structures comprising small molecules typically have not been used or considered for industrial catalytic applications because they can be mechanically fragile and/or less stable than conventional catalysts due to the weak intermolecular forces of the small molecules of the self-assembled structure, and thus may tend to decompose in solution. For example, conventional methods have attempted to use self-assembled structures as platforms for further applications, but these structures are not physically or chemically stable due to the lack of strong intermolecular cohesion between the constituent molecules, and thus the platforms are not suitable for catalysis (e.g., or other applications) after functionalization, e.g., by metal nanoparticles.

In contrast, some aspects of the present disclosure are related to nanostructures comprising aramid amphiphiles (AAs). Compared to metal oxide particles, the surface chemistry of aramid amphiphile self-assembled nanostructures is more tunable, which facilitates the opportunity of binding the functional moieties (e.g., metal nanoparticles) that are prepared separately from the aramid amphiphiles. For example, in the case of metal nanoparticles, the synthesis of metal nanoparticles from a salt solution may be controlled to form sub-nm diameter metal nanoparticles. Therefore, the AA platform may be functionalized with and thus utilize the relatively high catalytic activity of small metal nanoparticles (e.g., 10's of nm down to sub-nm diameter NPs) that are synthesized separately. Furthermore, the entire surface of the nanostructures comprising AAs may anchor the nanoparticles (e.g., as opposed to only defect sites as in metal oxide particles), which leads to a high loading ratio. Moreover, the nm-scale of the nanostructures provide a large surface area (e.g., when considering a surface area to volume ratio) for higher loadings and thus a faster catalytic reaction.

In some embodiments, the self-assembled structures disclosed herein have the advantage of both tunable surface chemistry and large surface areas. Self-assembled platforms comprising aramid amphiphiles (AA), having the hallmark features of Kevlar in high strength, toughness, and chemical stability, form 5 nm wide nanoribbons with strengths greater than steel when added to water, in some cases. The individual AA nanoribbons (e.g., and other nanostructures, such as nanotubes, nanoparticles, or the like) form flexible threads that are mechanically robust and stable in both water and air, according to some embodiments. Some aspects of the present disclosure are related to introducing functional moieties onto and/or into the self-assembled structures comprising AAs for catalytic applications.

Some aspects are related to nanostructures. According to some embodiments, the nanostructures comprise an aramid amphiphile and a functional moiety associated with the aramid amphiphile, wherein the functional moiety is configured to catalyze a chemical reaction. In some embodiments, the nanostructure comprises an aramid amphiphile and a functional moiety selected from the group consisting of a nanoparticle, an enzyme, and a metal complex, wherein the functional moiety is associated with the aramid amphiphile. According to some embodiments, the nanostructure comprises an aramid amphiphile comprising a charged cysteine group and a functional moiety selected from the group consisting of a nanoparticle, an enzyme, and a metal complex, wherein the functional moiety is covalently bound to the aramid amphiphile through the cysteine.

Wherever “particle,” “nanoparticle,” “nanostructure,” or a like term is used herein, it is to be understood that the object may or may not be suspensible in aqueous solution. Such objects can be interchangeable (e.g., where “particle” is used, a nanostructure can be used, if different, and vice versa, etc.). A nanostructure is typically a solid object including at least one cross-sectional dimension on the nanoscale (e.g., less than 1 micron and greater than or equal to 1 nanometer). These include, without limitation, nanoparticles, hollow nanospheres (e.g., vesicles), nanotubes, nanoribbons, two-dimensional materials, or the like, which may be modified with other components. For example, as described elsewhere herein, the nanostructures may comprise a self-assembled structure (e.g., a nanotube, nanoribbon, or the like) comprising an aramid amphiphile and a functional moiety associated with the aramid amphiphile. In some embodiments, both the self-assembled structure and the functional moiety are nanoscale. In some cases, the nanostructure comprising the self-assembled structure and the functional moiety is nanoscale.

In accordance with some embodiments, the nanostructures described herein comprise a plurality (e.g., a multiplicity) of aramid amphiphiles. In some such embodiments, the plurality of aramid amphiphiles self-assemble to form structures such as nanoribbons, nanotubes, and/or nanospheres. Furthermore, in some such embodiments, there may be a plurality (e.g., a plurality) of functional moieties associated with the plurality of aramid amphiphiles.

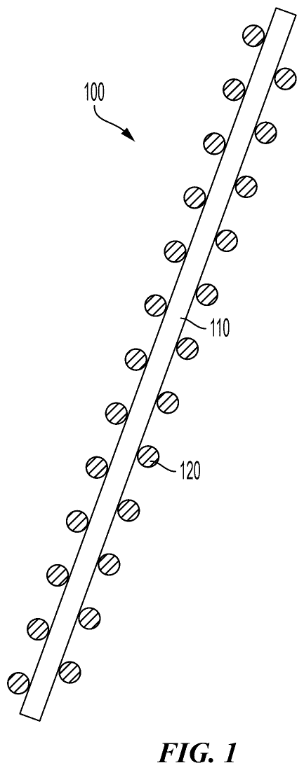

For example, FIG. 1 is a schematic diagram of an example embodiment of a nanostructure 100. The nanostructure 100 comprises a nanoribbon 110 comprising a plurality of aramid amphiphiles arranged in the nanoribbon 110, wherein the nanoribbon 110 is decorated with a plurality of functional moieties 120. In this case, the nanoribbon 110 comprises self-assembled aramid amphiphiles and the functional moiety 120 comprises Au nanoparticles.

Aramid amphiphiles may be used to self-assemble and form structures, in accordance with some embodiments. By adjusting the molecular design, tuned self-assembled structures are possible, which include, but are not limited to, spherical molecular nanoparticles, ribbon-like nanofibers, nanotubes, and vesicle-like hollow spheres. The structures comprising aramid amphiphiles do not decompose or dissociate on surfaces or under relatively harsh conditions, in accordance with some embodiments.

Aramids are known by those or ordinary skill in the art. Aramids generally comprise aromatic polyamide groups. Aramid amphiphiles are aramid-containing molecules that have a hydrophilic and a hydrophobic domain. The aramid amphiphiles may have a hydrophilic head group, a rigid core comprising an aramid structure, and/or a hydrophobic tail group. Various chemical motifs are possible for the components of the aramid amphiphiles (e.g., the hydrophilic head group, the hydrophobic alkyl group, and the aramid structural domain), various examples of which, as well as the syntheses of some example motifs, are described in US Patent Publication Number 2020/0298194, which is herein incorporated by reference in its entirety.

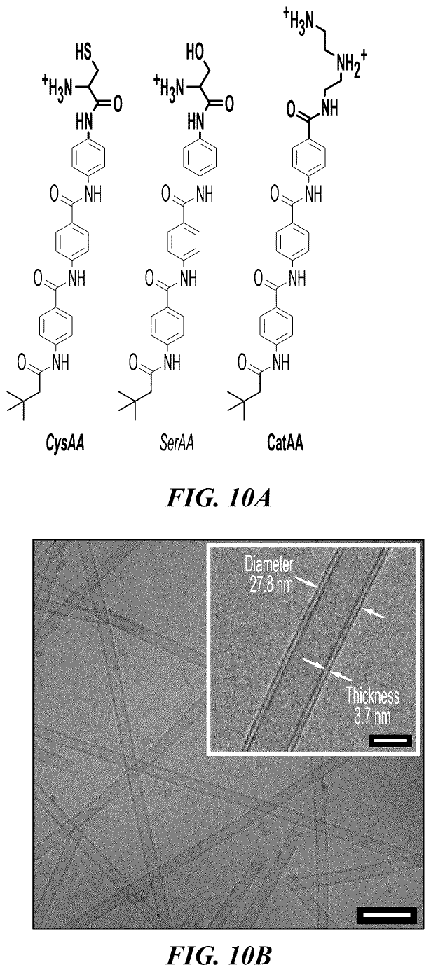

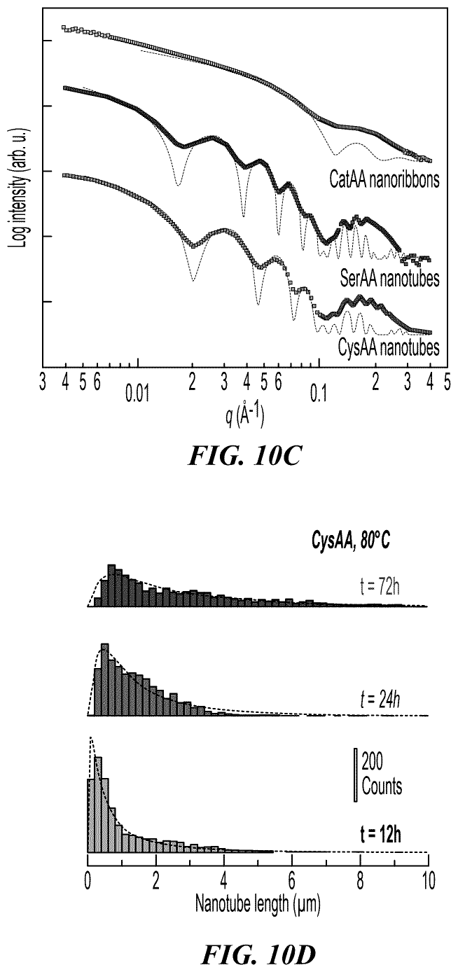

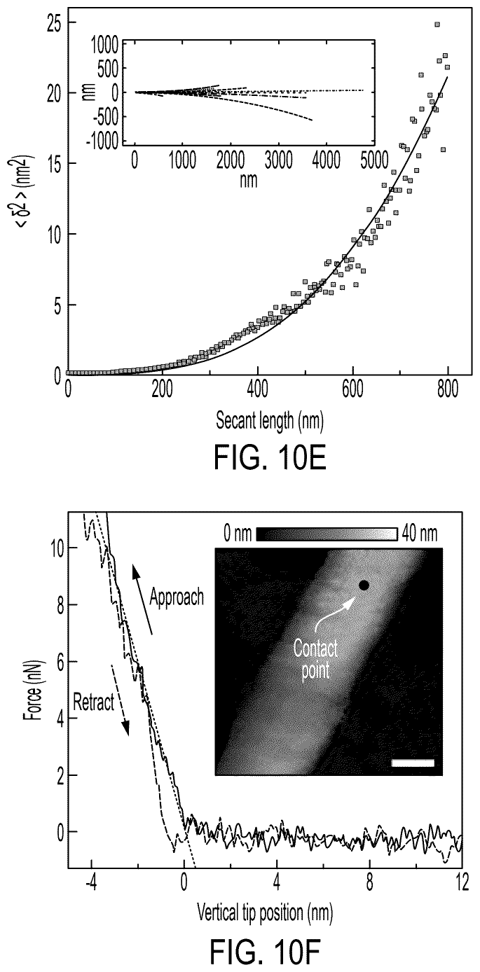

The chemical motif that gives rise to various structures (e.g., nanoparticles, hollow nanospheres, nanotubes, nanoribbons, etc.) nanostructures include monoaramid, diaramid, triaramid, etc. structural domains. Examples of triaramid structural domains having different hydrophilic head groups and the same hydrophobic tail group are shown in FIG. 10A. In accordance with some embodiments, the hydrophilic head group of aramid amphiphiles may be modified to include cationic, anionic, zwitterionic, and/or uncharged moieties to create charged structures. The head group may be a heavy metal chelator, in some cases. The hydrophilic head group may be an amino acid, an amino acid derivative, or a peptide, for example, a peptide of two, three, four, five, six, seven, eight, nine or ten amino acids, in accordance with some embodiments. Peptides comprising more amino acids and/or peptides comprising amino acid derivatives are possible. The amino acids may be the same or different when multiple amino acids are present. When the hydrophilic head group is a peptide, the peptide may have an affinity for a surface of a cell or a protein, in some cases. In some embodiments, the hydrophilic head group may have an affinity for certain compositions. For example, in some such cases, the hydrophilic head group may have an affinity for functional moieties, as described elsewhere herein. The affinity of the hydrophilic head group for the functional moieties may lead to associating, e.g., chemical bonding, ionic bonding, covalent bonding, and/or attraction via van der Waals forces, between the aramid amphiphile (e.g., the hydrophilic head group thereof) and the functional moiety. Additionally, the hydrophobic tail groups may be any of a variety of hydrophobic groups, in some embodiments, including, but not limited to, alkyl groups of arbitrary length or include multiple alkyl groups, alkenyl, alkynyl, fluorinated, siloxane, and/or aromatic groups.

In some embodiments, the hydrophilic head group of the aramid amphiphile may by selected and/or synthesized because it has an affinity for the functional moieties. In some such cases, the affinity may result in an association (e.g., a chemical bond, a covalent bond, van der Waals forces, or the like as described elsewhere herein) between the hydrophilic head group and the functional moiety. In some cases, the hydrophilic head group of the aramid amphiphile comprises a single amino acid. In some cases, the hydrophilic head group may comprise various chemical motifs, such as carbonyls, hydroxyls, amides, amines, sulfonates, and/or phosphates. In some cases, the hydrophilic head group comprises a cationic triazaheptane hydrophilic domain. In some cases, the hydrophilic head group of the aramid amphiphile comprise peptides, e.g., multiple amino acids (e.g., 2 amino acids, 3 amino acids, 4 amino acids, and so forth). In some cases, the hydrophilic head group of the aramid amphiphile comprises amino acid derivatives. In some cases, the amino acid comprises cysteine, serine, and/or glycine. According to some embodiments, the aramid amphiphile comprises cysteine, serine, and/or glycine. In accordance with some embodiments, the aramid amphiphile comprises cysteine. In accordance with some embodiments, the aramid amphiphile comprises a charged cysteine. In some embodiments, the aramid amphiphile is a cysteine aramid amphiphile (Cys AA), as follows:

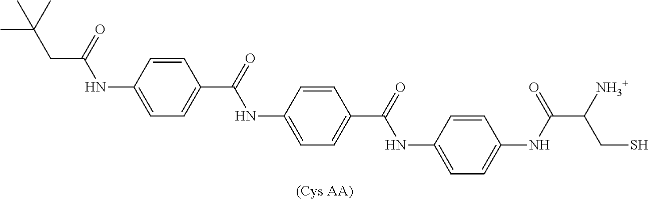

The surfaces of the self-assembled structures may be functionalized with arbitrary surface groups, for example, by self-assembly in the presence of multiple types of self-assembled structures. As a result, robust, mechanically stable, nanostructures may be formed with one or more functionalities present at the surface with chosen ratios, concentrations, and/or chemistries. Such tunability of the surface chemistry may facilitate the later association (e.g., chemical bonding, or the like as described elsewhere herein) of a functional moiety to the self-assembled structure to form the nanostructures described herein, in accordance with some embodiments. In some embodiments, self-assembly of the structure comprising aramid amphiphiles and then later association with a functional moiety, as described in more detail elsewhere herein, may facilitate the formation of nanostructures with a wider variety of functional moieties. For instance, tethering a relatively large functional moiety (e.g., a nanoparticle, an enzyme, and/or a metal complex) to the aramid amphiphiles before self-assembly of the aramid amphiphiles into a structure may discourage and/or disable the self-assembly of the aramid amphiphile-functional moiety complexes into self-assembled, for example, due to limited mass transport and/or steric hindrance brought by the relatively large functional moiety. Accordingly, some of the nanostructures disclosed herein may only be formed by allowing the aramid amphiphiles to self-assemble into a structure and then subsequently introducing a solution comprising the functional moiety such that the self-assembled structure and functional moiety may associate.

According to some embodiments, the self-assembled structures comprising aramid amphiphiles may have any of a variety of structures. In some cases, the self-assembled structures may be spherical, nanotubes, nano ribbons, or vesicles (e.g., hollow spheres). Other structures are possible. According to some embodiments, the self-assembled structure of the aramid amphiphiles may be dependent on the composition of hydrophilic head group, the hydrophobic alkyl tail group, and/or the multiplicity of the aramid structural domain of the aramid amphiphiles.

According to some embodiments, the self-assembled structures comprising aramid amphiphiles may have any of a variety of sizes. In some cases, the self-assembled structures may have an average smallest dimension of less than or equal to 1 micron, less than or equal to 500 nanometers, less than or equal to 250 nanometers, less than or equal to 100 nanometers, less than or equal to 50 nanometers, less than or equal to 20 nanometers, less than or equal to 10 nanometers, less than or equal to 8 nanometers, less than or equal to 6 nanometers, less than or equal to 4 nanometers, or less than or equal to 2 nanometers. Other ranges are also possible.

In some cases, the self-assembled structures may have a maximum average dimension of greater than or equal to 100 nanometers, greater than or equal to 1 micron, greater than or equal to 2 microns, greater than or equal to 5 microns, greater than or equal to 10 microns, greater than or equal to 25 microns, greater than or equal to 50 microns, greater than or equal to 100 microns, greater than or equal to 500 microns, greater than or equal to 1 millimeter, greater than or equal to 2 millimeters, greater than or equal to 5 millimeters, greater than or equal to 1 centimeter, greater than or equal to 5 centimeters, greater than or equal to 10 centimeters, or greater than or equal to 50 centimeters. In some cases, the average maximum dimension of the self-assembled structures may be less than or equal to 100 centimeters, less than or equal to 50 centimeters, less than or equal to 10 centimeters, less than or equal to 5 centimeters, less than or equal to 1 centimeter, less than or equal to 5 millimeters, less than or equal to 2 millimeters, less than or equal to 1 millimeter, less than or equal to 500 microns, less than or equal to 100 microns, less than or equal to 50 microns, less than or equal to 25 microns, less than or equal to 10 microns, less than or equal to 5 microns, less than or equal to 2 microns, or less than or equal to 1 micron. Combinations of the foregoing ranges are possible (e.g., greater than or equal to 1 micron and less than or equal to 100 cm). Other ranges are also possible.

In some embodiments, depending on the self-assembled structure, the self-assembled structure may have any of a variety of aspect ratios (e.g., a ratio of width to length). For example, in the case where the self-assembled structure comprises a nano ribbon and/or nanotube, the self-assembled structure may have a relatively high aspect ratio. The aspect ratio, in accordance with some embodiments, may be greater than or equal to 1:1, greater than or equal to 1:2, greater than or equal to 1:5, greater than or equal 1:10, greater than or equal 1:20, greater than or equal 1:25, greater than or equal 1:30, greater than or equal 1:50, greater than or equal 1:100, greater than or equal 1:200, greater than or equal 1:300, greater than or equal 1:500, or greater than or equal 1:750. In some cases, the aspect ratio may be less than or equal to 1:1000, less than or equal 1:750, less than or equal 1:500, less than or equal 1:300, less than or equal 1:200, less than or equal 1:100, less than or equal, 1:50, less than or equal 1:30, less than or equal 1:25, less than or equal 1:20, less than or equal 1:10, less than or equal 1:5, or less than or equal 1:2. Combinations of the foregoing ranges are possible (e.g., greater than or equal to 1:100 and less than or equal to 1:1000). Other ranges are also possible. As an example, a nanoribbon having aspect ratio of greater than or equal to 1:25 and a width of 10 nm would have length of at least 250 nm (e.g., 10 nm*25).

In some embodiments, the self-assembled structures comprising aramid amphiphiles may be relatively stiff. In some cases, the stiffness of the self-assembled structure along the transverse direction of the self-assembled structure (e.g., a nanotube) may be measured by force displacement measurements, for instance, as applied via an atomic force microscopy (AFM) tip. In some embodiments, the stiffness of the self-assembled structure along the transverse direction of the self-assembled structure is at least 0.1 N/m, at least 0.5 N/m, at least 1 N/M, at least 1.5 N/m, at least 2 N/m, at least 2.5 N/m, at least 3 N/m, at least 3.5 N/m, at least 4 N/m, at least 4.5 N/m, at least 5 N/m, at least 6 N/m, at least 7 N/m, at least 8 N/m, or at least 9 N/m. In some cases, the stiffness of the self-assembled structure along the transverse direction of the self-assembled structure is no more than 10 N/m, no more than 9 N/m, no more than 8 N/m, no more than 7 N/m, no more than 6 N/m, no more than 5 N/m, no more than 4.5 N/m, no more than 4 N/m, no more than 3.5 N/m, no more than 3 N/m, no more than 2.5 N/m, no more than 2 N/m, no more than 1.5 N/m, no more than 1 N/m, or no more than 0.5 N/m. Combinations of the foregoing ranges are possible (e.g., at least 1 N/m and no more than 5 N/m). Other ranges are also possible.

Functional moieties may be associated with the aramid amphiphiles, in accordance with some embodiments. The functional moiety may be any of a variety of moieties. In some embodiments, the functional moiety may be configured to catalyze a reaction, for example, homogeneously in solution. In some embodiments, the nanostructures are distributed homogeneously in solution, and the nanostructures comprise the functional moieties. Accordingly, when used herein, “homogeneous catalysis” may refer to homogeneous catalysis as known to those skilled in the art, but may also refer to quasi-homogeneous catalysis, wherein the functional moieties are associated with the nanostructures instead of the functional moieties being uniformly distributed in solution. In some embodiments, the functional moiety may be a catalyst. Thus, in some such cases, the functional moiety may be configured to catalyze a reaction. Being configured to catalyze a reaction would be understood by those of ordinary skill in the art. Generally, being configured to catalyze a reaction indicates the functional moiety acts as a catalyst, wherein the functional moiety lowers the energy of a transition state and/or provides an alternative reaction pathway with a lower energy of activation than the main reaction pathway (e.g., by bringing multiple reactants together, providing stabilizing forces for the transition state or the reactant, binding with a reactant, etc.) such that the reactant may convert to a product with relatively less energy input than when the catalyst is absent, all without consuming the catalyst.

In some embodiments, the functional moiety may be configured to perform thermal catalysis. In some embodiments, the functional moiety may be configured to perform bio-catalysis (e.g., via an enzyme). In some embodiments, the functional moiety may be configured to perform photocatalysis. For example, when present, the functional moiety may lower an activation barrier to convert a reactant to a product, thereby increasing a rate of the reaction.

Accordingly, the functional moiety may have any of a variety of identities, in some embodiments. For example, in some cases, the functional moiety may comprise a nanoparticle, a molecular catalyst, a protein (e.g., an enzyme), and/or a metal complex. In some cases, the functional moiety may be selected from the group consisting of a nanoparticle, a molecular catalyst, a protein (e.g., an enzyme), and/or a metal complex. In some cases, the functional moiety may be selected from the group consisting of a nanoparticle, an enzyme, and/or a metal complex. In some such embodiments, the nanoparticle, the enzyme, and/or the metal complex comprise a noble metal catalyst. In some cases, the functional moiety does not comprise a photosensitizer, and accordingly, the functional moiety is not configured to photo-catalytically catalyze a reaction. In some embodiments, as described herein, the functional moiety may be associated with the aramid amphiphile of the nanostructure. In some cases, the aramid amphiphile does not comprise the functional moiety.

In some cases, wherein the functional moiety comprises a nanoparticle, the nanoparticle may comprise Au, Ag, Pt, Cu, Rh, Ir, Pd, Fe, Ru, Ti, Ni, other transition metals, oxides thereof, and/or other compounds (e.g., nitrides, hydroxides, etc.) thereof. Other metals are also possible. In some cases, the metals of the nanoparticles may be alloyed, e.g., uniformly and/or partially to form complex structures such as core-shell structures. According to some embodiments, wherein the functional moiety comprises a nanoparticle, the association of the functional moiety with the self-assembled structure comprising aramid amphiphiles may result in a nanostructure wherein the functional moiety is relative stable, for example, in contrast to the functional moiety being free in solution (e.g., unbound to a surface or structure). Stability of the functional moiety of the nanostructure may also prevent and/or mitigate aggregation of the functional moiety, which may occur in the absence of the other components of the nanostructure (e.g., in the absence of aramid amphiphiles, the functional moieties may aggregate more than in the presence). For instance, in some embodiments, the functional moieties may be associated with aramid amphiphiles of the nanostructures. In some such embodiments, the functional moieties may be stable such that their size changes little (e.g., a maximum average dimension of the moiety changes by less than or equal to 50%, less than or equal to 25%, less than or equal to 10%, less than or equal to 5%, or less of an initial maximum average dimension of the functional moiety) or does not change after performing catalysis. In some cases, the functional moieties may not aggregate due to the relatively strong association (e.g., a chemical bond) between the functional moieties and the aramid amphiphiles of the nanostructures.

In some embodiments, wherein the functional moiety comprises a metal complex, the metal complex may comprise various metals as outlined above for nanoparticles and/or additional ligands complexed with the metal. For example, in some cases, carbonyls, phosphines, carbenes, porphyrins, and/or amines are possible ligands. Other ligand classes are also possible. In some cases, the ligands of the metal complexes may be monodentate ligands, bidentate ligands, and/or multidentate ligands. In some embodiments, wherein the functional moiety comprises a metal complex, the metal complex may comprise a protoporphyrin IX and/or bipyridine.

Functional moieties comprising enzyme catalysts, in accordance with some embodiments, may comprise amino acids arranged as a protein having an active site. In some embodiments, the protein may have an active site, which may comprise a metal, and which may facilitate the catalysis of the reaction. In other embodiments, the protein may have an active site and the active site may not contain a metal. In some embodiments, multiple enzymes (e.g., coenzymes) and/or additional metals (e.g., cofactors) are possible. Additionally, in some cases, the functional moiety may comprise a molecular catalyst, for instance, comprising a metal. In other cases, the functional moiety may comprise a molecular catalyst, for instance, not comprising a metal. In some cases, the catalyst may comprise an organocatalyst, comprising amines, phosphines, and/or organic bases and/or acids.

As noted, in some embodiments, the functional moiety is associated with an aramid amphiphile. “Associated with,” in this context, means the functional moiety is provided in relation to the aramid amphiphile in such a manner that the aramid amphiphile and the functional moiety are in proximity to each other. In some cases, there may be a plurality of aramid amphiphiles self-assembled in a structure, wherein the functional moiety may then be associated with one or more of the plurality of aramid amphiphiles. The functional moiety and aramid amphiphile can be provided in proximity by being immobilized near to each other via covalent or non-covalent bond, being commonly immobilized to a common entity such as a chemical linker, substrate surface, surface of a nanoparticle, etc., and/or being covalently or non-covalently bound directly to each other.

In some cases, the functional moiety being associated with an aramid amphiphile may comprise the functional moiety being chemically bound to the aramid amphiphile. In some embodiments, the functional moiety being associated with an aramid amphiphile may comprise the functional moiety being covalently bound to the aramid amphiphile. In some embodiments, the functional moiety being associated with an aramid amphiphile may comprise having relatively strong intermolecular forces (e.g., van der Waals forces) between the functional moiety and the aramid amphiphile. In some embodiments, the functional moiety being associated with an aramid amphiphile may comprise ionic bonding between the functional moiety and the aramid amphiphile. In some embodiments, an association between the aramid amphiphile and the functional moiety may comprise multiple of the foregoing types of associations, for example, a covalent bond and van der Waals forces between the aramid amphiphile and the functional moiety. In some embodiments, the aramid amphiphiles may be configured to self-assemble into a structure, whereby functional moieties may then be introduced to the self-assembled structure (e.g., by mixing a first solution comprising the self-assembled structure and a second solution comprising the functional moiety). Following this introduction, for example, the self-assembled structure comprising the aramid amphiphiles and the functional moiety may then associate to form the nanostructures as disclosed herein, for instance, by forming a chemical bond.

In some embodiments, there may be multiple types of functional moieties present. In some embodiments, the multiple types of functional moieties may be present on a single nanostructure. In some cases, the multiple types of functional moieties may be present on separate nanostructures, wherein the nanostructures are homogeneously distributed in a solution. In some cases, multiple types of aramid amphiphiles may be present in the nanostructure. For instance, a first aramid amphiphile comprising cysteine and a second aramid amphiphile comprising serine may self-assemble together to form a structure present in a nanostructure, wherein a first functional moiety associates with the first aramid amphiphile and a second functional moiety associated with the second aramid amphiphile.

In some cases, the multiple types of functional moieties may be configured to catalyze a single reaction together, for instance, by facilitating two subsequent reactions to convert a reactant to a target product. For example, a first functional moiety may convert a reactant to an intermediate and a second functional moiety mat convert the intermediate to the target product. As an example, a first functional moiety may be configured to reduce CO₂ to CO and a second functional moiety may be configured to further reduce CO, for instance, to CH₄. In some cases, multiple functional moieties may work in concert to catalyze a single reaction, for example, reduction of CO₂ to CO. In other embodiments, the multiple types of functional moieties may be configured to catalyze different reactions. Other reactions are possible, as this disclosure is not so limited.

The functional moiety may be any of a variety of sizes, in accordance with some embodiments. For example, as described above, in some cases the functional moiety may be a molecular catalyst, and thus an average maximum dimension may be less than or equal to 10 nanometers, less than or equal to 5 nanometers, less than or equal to 2 nanometers, and/or less than or equal to 1 nanometer. In some embodiments, the functional moiety may be relatively larger than a single molecule, for example, an enzyme or a nanoparticle. In some embodiments, an average maximum dimension of the functional moiety may be greater than or equal to 1 nanometer, greater than or equal to 2 nanometers, greater than or equal to 5 nanometers, greater than or equal to 10 nanometers, greater than or equal to 25 nanometers, or greater than or equal to 50 nanometers. In some embodiments, an average maximum dimension of the functional moiety may be less than or equal to 100 nanometers, less than or equal to 50 nanometers, less than or equal to 25 nanometers, less than or equal to 10 nanometers, less than or equal to 5 nanometers, or less than or equal to 2 nanometers. Combinations of the foregoing ranges are also possible (e.g., greater than or equal to 1 nanometer and less than or equal to 10 nanometers, greater than or equal to 1 nanometer and less than or equal to 25 nanometers). Other ranges are also possible.

In some embodiments, for example when the functional moiety is a nanoparticle, the functional moieties may be relatively uniform in size. This may be due to the ability to use conventional synthesis methods for the functional moieties (e.g., seed mediated growth), wherein the functional moieties are then subsequently associated with the self-assembled structures, as described elsewhere herein. In some cases, the average maximum dimension of the functional moieties may vary by no more than 10 nanometers, no more than 5 nanometers, no more than 3 nanometers, no more than 2 nanometers, or no more than 1 nanometer. Relatively monodisperse functional moieties obtained using conventional methods may have relatively uniform and/or high catalytic activity, which may improve the functionality of the nanostructures for catalysis, as described herein.

The functional moiety may be present on the surface of the self-assembled structure comprising aramid amphiphiles in any of a variety of amounts. The loading of the functional moiety on the surface of the self-assembled structure may depend on any of a variety of factors, in accordance with some embodiments. For example, in some cases, the loading of the functional moiety on the surface of the self-assembled structure may be dependent on the concentration of functional moieties in solution when introduced to the self-assembled structures. In some embodiments, the loading may depend on the size of the self-assembled structures and/or the size of the functional moieties. In accordance with some embodiments, the loading may depend on the association of the function moiety with the self-assembled structure, as described herein.

In some cases, the functional moiety may be loaded on the nanostructure such that there are no more than 10,000, nor more than 1,000, no more than 100, no more than 50, no more than 25, no more than 10, no more than 5, or no more than 1 aramid amphiphile per functional moiety. In some embodiments, when the functional moiety is loaded such that there are multiple aramid amphiphiles present in the nanostructure per functional moiety, multiple aramid amphiphiles may be associated with each functional moiety. For example, in some cases, multiple aramid amphiphiles comprising a cysteine may form covalent bonds with a functional moiety comprising Au nanoparticles.

In some embodiments, the functional moieties may be present in any of a variety of amounts. In some cases, the loading may be determined by counting the number of moieties per nanostructure, for example, by viewing the nanostructure in an electron microscope. In some embodiments, the functional moieties may be present in an amount of greater than or equal to 10, greater than or equal to 100, greater than or equal to 1,000, or greater than or equal to 10,000 moieties per nanostructure. In some cases, the functional moieties may be present in an amount of less than or equal to 100,000, less than or equal to 10,000, less than or equal to 1,000, less than or equal to 100 moieties per nanostructure. Combinations of the foregoing ranges are possible (e.g., greater than or equal to 100 and less than or equal to 100,000). Other ranges are also possible.

Some aspects are related to compositions. In some cases, the compositions comprise a solution or suspension, the nanostructures as described elsewhere herein, and a reactant in the solution or suspension. In some embodiments, the functional moieties of the nanostructures are configured to homogeneously catalyze the reactant to a product. In some embodiments, the solution comprises water. In some embodiments, the solution is aqueous. In some cases, the solution may comprise a nonpolar solvent. In some embodiments, the solvent may comprise polar aprotic solvents. Example solvents include, but are not limited to, chloroform, dichloromethane, tetrahydrofuran, ethyl acetate, pentane, hexane, cyclohexane, benzene, toluene, diethyl ether, and xylene. Additionally, the solution may also comprise combinations of solvents (e.g., two solvents, three solvents, four solvents, and so forth) in various ratios (e.g., 1:1, 1:2, 1:5, 1:10, 1:20, and so forth), according to some embodiments. In some embodiments, the solution may further comprise a reactant, wherein the reactant may undergo a reaction to form a product, for example, in the presence of a functional moiety (e.g., a catalyst) such as some of the nanostructures described herein.

Some aspects are related to methods. In some embodiments, the nanostructures may be used to catalyze a chemical reaction. For instance, in some such cases, nanostructures may be provided in a solution or suspension and then the nanostructures may catalyze a conversion of a reactant to a product in the solution or suspension. In some cases, catalyzing a reaction indicates lowering an activation barrier associated with the reaction. The reaction may include converting a reactant to a product, wherein the conversion may not happen in the absence of the catalyst, according to some embodiments. In some embodiments, the method may comprise converting a reactant to a product in a solution or suspension, the solution or suspension comprising the nanostructure and separating the nanostructure from the solution or suspension.

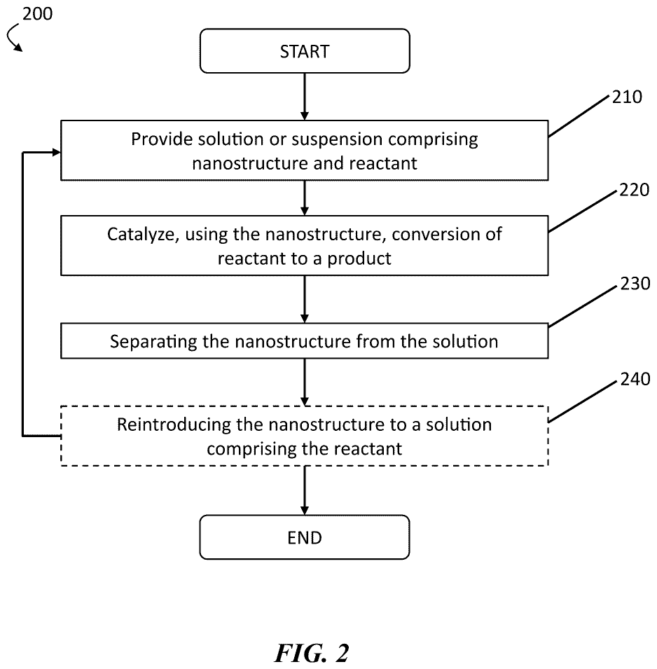

FIG. 2 shows a flow diagram of an example method 200. In the method, a solution comprising the nanostructures as described elsewhere herein and a reactant is provided 210. The nanostructures then catalyze the conversion of the reactant to a product 220. Following this, the nanostructures may be separated from the solution 230, for example, by a filter. The nanostructures may then optionally (e.g., dashed box) be reintroduced into a solution comprising the reactant 240 to again provide a solution comprising the nanostructures and the reactant, that is, restart the method at step 210. In some cases, however, the nanostructures may not be reused. Other methods may comprise some or all of the steps shown in FIG. 2.

In some embodiments, the solution in which the nanostructure is present may be provided. Note that while referred to as a solution in various embodiments, one could also use a suspension comprising the nanostructures as described above. In some cases, providing the solution may comprise preparing a solution. For example, in some cases, the nanostructure may be synthesized and then suspended or dissolved in a solution, respectively. According to some embodiments, the solution may be provided in that the nanostructure is may be present in the solution (e.g., the nanostructures were synthesized elsewhere).

The nanostructures may be synthesized in any of a variety of ways, in some embodiments. Some aspects of the method may be related to the example methods described in US Patent Publication 2020/0298194. For example, the aramid amphiphiles may be heated in solution to form the self-assembled structures comprising the aramid amphiphiles. In some cases, the solution is heated to an average temperature of greater than or equal to 25 degrees C., greater than or equal to 30 degrees C., greater than or equal to 40 degrees C., greater than or equal to 50 degrees C., greater than or equal to 60 degrees C., greater than or equal to 70 degrees C., or greater than or equal to 80 degrees C. In some cases, the solution is heated to an average temperature of less than or equal to 90 degrees C., less than or equal to 80 degrees C., less than or equal to 70 degrees C., less than or equal to 60 degrees C., less than or equal to 50 degrees C., less than or equal to 40 degrees C., or less than or equal to 30 degrees C. Combinations of the foregoing ranges are possible. Other ranges are also possible.

According to some embodiments, the solution may be heated to an elevated temperature for any of a variety of times, in accordance with some embodiments, which may affect the size of the resulting self-assembled structures. For instance, in some cases, the solution comprising aramid amphiphiles may be heated for at least 3 hours, at least 6 hours, at least 12 hours, at least 18 hours, at least 24 hours, at least 36 hours, at least 48 hours, at least 72 hours, or at least 96 hours to form the self-assembled structures. In some embodiments, the solution comprising aramid amphiphiles may be heated for no more than 120 hours, no more than 96 hours, no more than 72 hours, no more than 48 hours, no more than 36 hours, no more than 24 hours, no more than 18 hours, no more than 12 hours, or no more than 6 hours to form the self-assembled structures. Combinations of the foregoing ranges are possible (e.g., at least 12 hours and no more than 72 hours). Other ranges are also possible.

The self-assembly of the aramid amphiphiles into structures may occur in a first solution. Following this, a second solution comprising the functional moiety may then be mixed with the first solution comprising the self-assembled structures comprising aramid amphiphiles. According to some embodiments, the introduction of the self-assembled structures and the functional moieties allows for the separate synthesis of the self-assembled structures and the functional moieties. As described elsewhere herein, the forming of the self-assembled structures and then the addition of the functional moieties may facilitate the formation of nanostructures that were heretofore unfeasible to obtain, as the combination of the functional moiety with the aramid amphiphile before self-assembly may have prevented the formation of the self-assembled structures. According to some embodiments, the functional moieties may have a relatively uniform size distribution due to being synthesized by conventional methods, which may allow for nanostructures comprising functional moieties having relatively uniform sizes. In some cases, the ability to form the nanostructures described herein may facilitate the use of the aramid amphiphile platform for any of a variety of catalytic reactions and/or with higher catalytic rates, as described elsewhere herein.

In some embodiments, after the solution is provided, the nanostructures in the solution may be used to perform catalysis. In some cases, the nanostructures may be used to perform homogeneous catalysis. According to some embodiments, in order to perform catalysis, a reactant may be added to the solution. In some cases, the reactant may be converted to a product when performing catalysis with the nanostructure in the solution. In accordance with some embodiments, as described elsewhere herein, the conversion of the reactant to the product may not proceed in the absence of the nanostructure. In some cases, the conversion of the reactant to the product may occur at a relatively slow rate in the absence of the nanostructure, when compared to the conversion in the presence of the nanostructure.

Depending on the functional moiety, any of a variety of catalytic reactions may be performed in the solution in the presence of the nanostructures. Various bond forming or breaking reactions (e.g., C—C bond formation, dehydrogenation), oxidation reactions (e.g., alcohol oxidation, CO oxidation, alkane oxidation), and/or reduction reactions (e.g., proton reduction, oxygen reduction, CO₂ reduction, CO reduction, alkene reduction) are possible depending on the functional moiety. For example, in some cases wherein the functional moiety is or comprises a gold nanoparticle, the functional moiety may catalyze the oxidation of ethanol.

Generally, the catalytic rate observed in the presence of the nanostructure may be any of a variety of values. In some embodiments, the catalytic rate observed may be relatively high, for example, due to the presence of the functional moiety of the nanostructure acting as a catalyst. According to some embodiments, and depending on the reaction being catalyzed, the nanostructure may catalyze a reaction at a turnover rate of greater than or equal to 0.1 s⁻¹, greater than or equal to 0.5 s⁻¹, greater than or equal to 1 s⁻¹, greater than or equal to 2 s⁻¹, greater than or equal to 3 s⁻¹, greater than or equal to 5 s⁻¹, greater than or equal to 10 s⁻¹, greater than or equal to 15 s⁻¹, greater than or equal to 20 s⁻¹, greater than or equal to 25 s⁻¹, greater than or equal to 30 s⁻¹, or greater than or equal to 40 s⁻¹. In some cases, the nanostructure may catalyze a reaction at a turnover rate of less than or equal to 50 s⁻¹, less than or equal to 40 s⁻¹, less than or equal to 30 s⁻¹, less than or equal to 25 s⁻¹, less than or equal to 20 s⁻¹, less than or equal to 15 s⁻¹, less than or equal to 10 s⁻¹, less than or equal to 5 s⁻¹, less than or equal to 3 s⁻¹, less than or equal to 2 s⁻¹, less than or equal to 1 s⁻¹, or less than or equal to 0.5 s⁻¹. Combinations of the foregoing ranges are possible (e.g., greater than or equal to 5 s⁻¹ and less than or equal to 25 s⁻¹, greater than or equal to 20 s⁻¹ and less than or equal to 25 s⁻¹, greater than or equal to 5 s⁻¹ and less than or equal to 10 s⁻¹). Other ranges are also possible.

In some cases, the catalytic rate observed in the presence of the nanostructures may be dependent on the temperature of the solution containing the nanostructures. In some cases, the average temperature of the solution may be greater than or equal to 10 degrees C., greater than or equal to 20 degrees C., greater than or equal to 30 degrees C., greater than or equal to 40 degrees C., greater than or equal to 50 degrees C., greater than or equal to 60 degrees C., greater than or equal to 70 degrees C., greater than or equal to 80 degrees C., or greater than or equal to 90 degrees C. during catalysis. In some embodiments, the average temperature of the solution may be less than or equal to 100 degrees C., less than or equal to 90 degrees C., less than or equal to 80 degrees C., less than or equal to 70 degrees T, less than or equal to 60 degrees C., less than or equal to 50 degrees C., less than or equal to 40 degrees C., less than or equal to 30 degrees C., or less than or equal to 20 degrees C. during catalysis. Combinations of the foregoing ranges are possible (greater than or equal to 20 degrees C. and less than or equal to 50 degrees C.). Other ranges are also possible.

As described elsewhere herein, conventional homogeneous catalyst may not be preferred in industry settings due to the inability to reuse the catalyst. For example, in a solution comprising a molecular catalyst, a reactant may be converted to a product using the molecular catalyst. The product may be obtained from the solution, wherein the molecular catalyst may then be wasted (e.g., not reused).

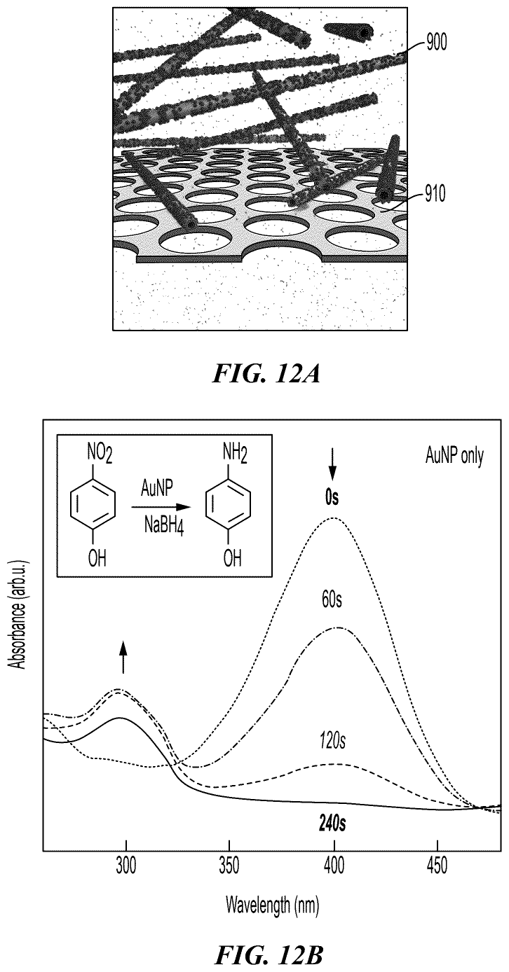

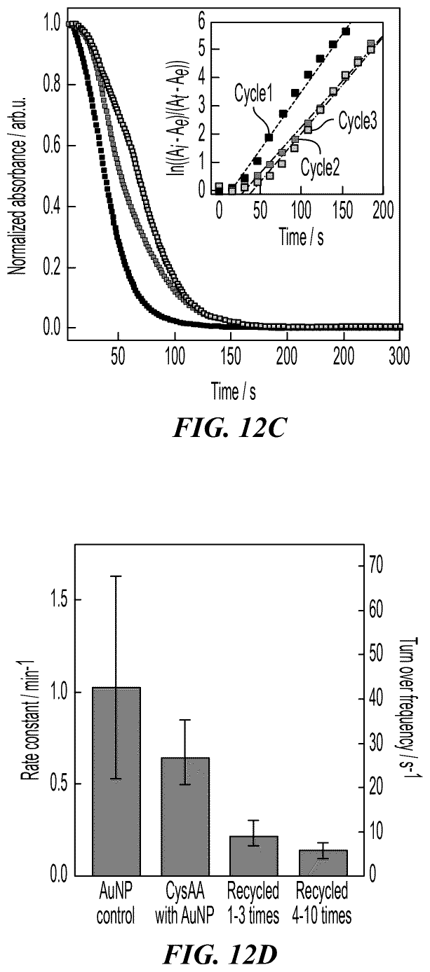

In contrast, the nanostructures described herein comprising aramid amphiphiles maybe particularly robust, in some embodiments. Accordingly, in some cases, a reactant may be converted to a product using the nanostructures described herein, and then the nanostructures may be separated from solution without the nanostructures degrading due to mechanical processes (e.g., physical separation on the basis of size). Separating the nanostructures, in accordance with some embodiments, may proceed in any of a variety of methods. In some cases, the nanostructures may be separated on the basis of size, for example, using a sieve, a membrane, size exclusion chromatography, and/or filter. In some cases, the nanostructures may be separated on the basis of charge, for example, using capillary electrophoresis and/or ion exchange chromatography. It may be particularly advantageous to separate the nanostructures on the basis of size using a membrane and/or a filter. In some such cases, the filter may comprise a syringe filter. Using a syringe filter, in accordance with some embodiments, may facilitate the application of pressure to the solution when separating the nanostructures from the solution. Other separation methods are also possible. For example, FIG. 12A shows a schematic illustration of nanostructures 900 being separated by using a filter 910.

In some cases, after separation from solution, the nanostructures maybe rinsed using an aqueous solution. In some cases, the aqueous solution may be deionized water. In other embodiments, the aqueous solution may contain various components, for example, and electrolyte.

The nanostructures may be reintroduced into a second solution (e.g., different from the initial solution where reactant was initially converted to product) after separation, in some cases, wherein the second solution may have substantially the same composition as the original solution (e.g., containing the reactant) did before catalysis occurred. In some embodiments, reintroducing the nanostructures to a second solution may comprise resuspending and/or redissolving the nanostructures within the second solution.

According to some embodiments, the nanostructures may be used to catalyze a first reaction in a solution, separated from the solution, and then reused to catalyze a second reaction in a second solution. In some embodiments, the first reaction and the second reaction are the same. In other cases, the first reaction the second reaction are different. In accordance with some embodiments, the nanostructures may be separated and reintroduced into another solution to catalyze a reaction in the solution any of a number of times, for example, a second time, a third time, a fourth time, and so forth. In some cases, the reusability of the nanostructures for homogeneous catalysis is advantageous because it may facilitate the ability to homogeneously (e.g., quasi-homogeneously) catalyze reactions multiple times. This may be desirable, in some cases, to take advantage of relatively higher catalytic rates of homogeneous catalysis when compared to heterogeneous catalysis, for example, due to increased mass transfer and/or catalyst loading relative to the amount of solution.

The following examples are intended to illustrate certain embodiments of the present invention, but do not exemplify the full scope of the invention.

### Example 1

In this example, an embodiment of the nanostructures is described and used as a catalyst.

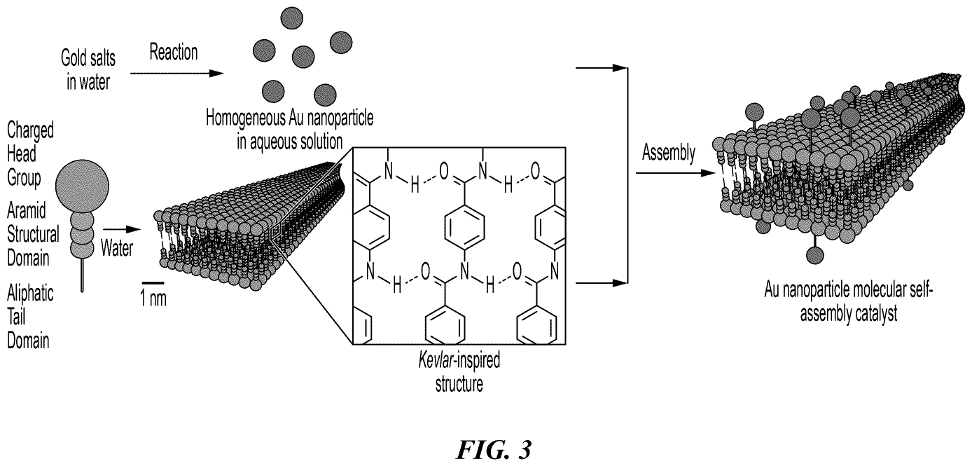

In this disclosure, gold nanoparticles (AuNPs), which possess high catalytic activity, were used as an example functional moiety to demonstrate the nanostructures having self-assembled structures comprising aramid amphiphiles (AAs) with catalytic surface chemistry. As shown in FIG. 3, a new type of AAs that contains a thiol functional group was designed and synthesized because the thiol functional group has a strong affinity with gold to form gold-sulfur covalent bonds. The cysteine amino acid-functionalized AAs (CysAAs) self-assemble into high-aspect-ratio nanostructures in water at 80° C. Then, a colloidal solution containing commercially available AuNPs is introduced to the AA solution to form the CysAA nanostructures.

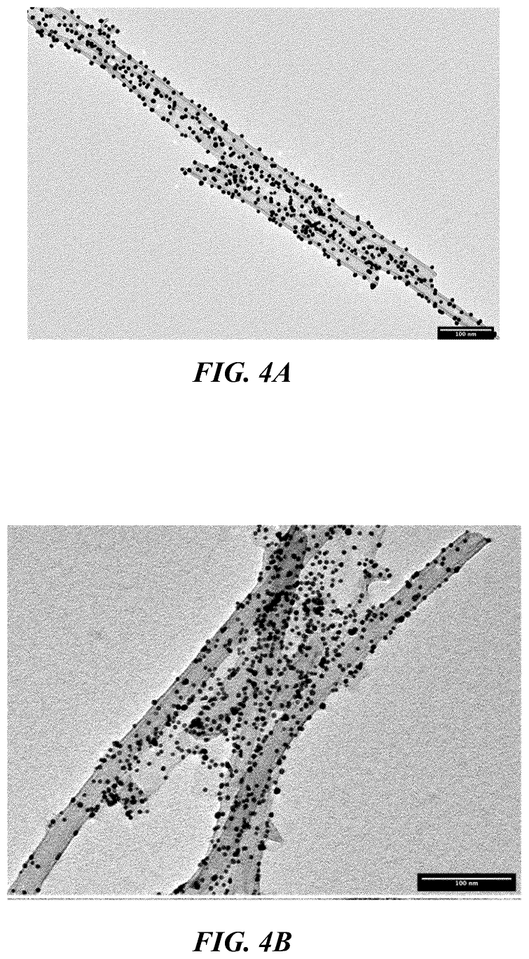

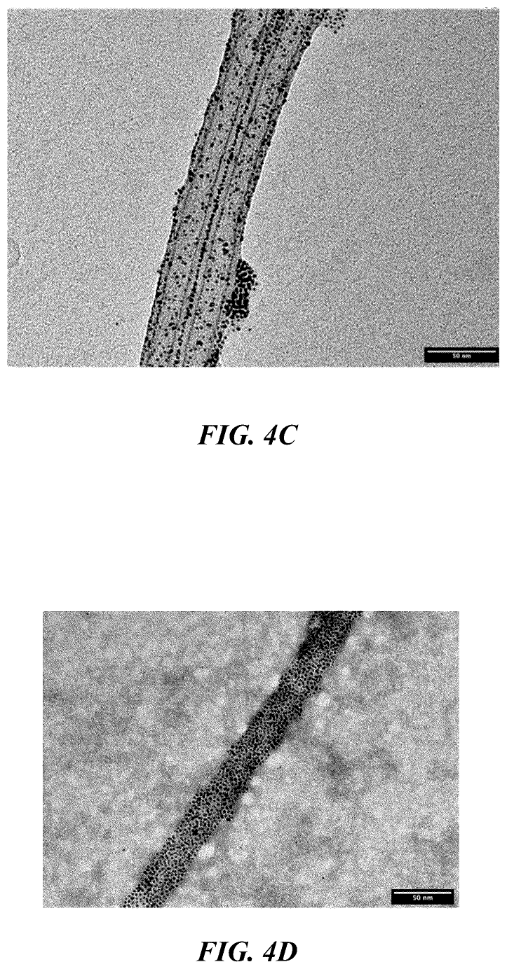

After introduction of the colloidal solution to the AA solution, the AuNPs were evenly distributed and anchored on the surface of CysAA nanotubes as shown in FIG. 4. FIG. 4 shows examples of 10 nm, 5 nm, and 1.8 nm gold nanoparticle-functionalized CysAA nanotubes (FIGS. 4A-4C). This indicates the bonding between AuNPs and thiol functional groups is not affected by the sizes of gold nanoparticles. Furthermore, FIG. 4D shows the loading ratio of the AuNPs on the self-assembled structure of aramid amphiphiles may be engineered by changing the volumetric ratio of AuNPs solution and CysAA nanotubes solution (e.g., more solution containing 1.8 nm AuNPs was added in the case of FIG. 4D when compared to FIG. 4C). In FIG. 4D, the maximum amount of AuNP loading on the CysAA is shown.

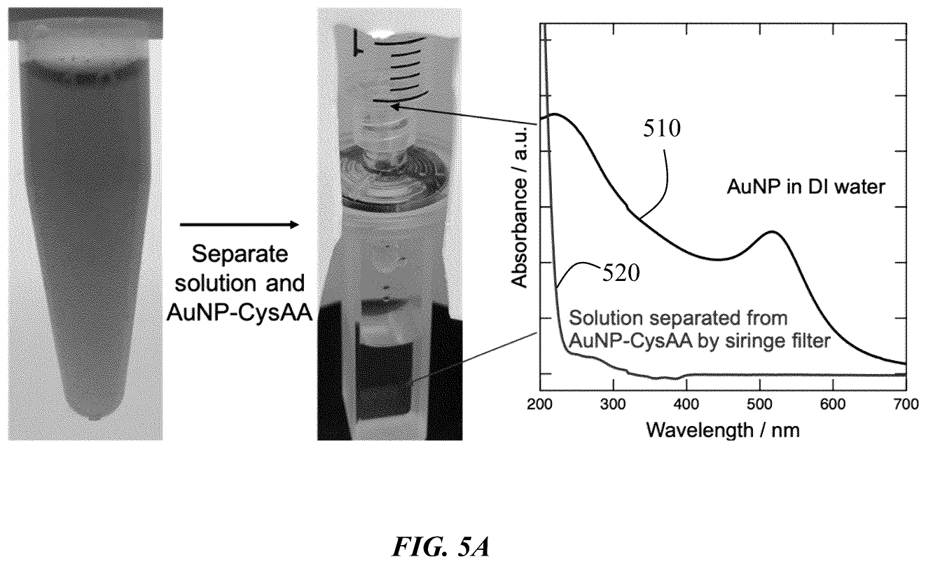

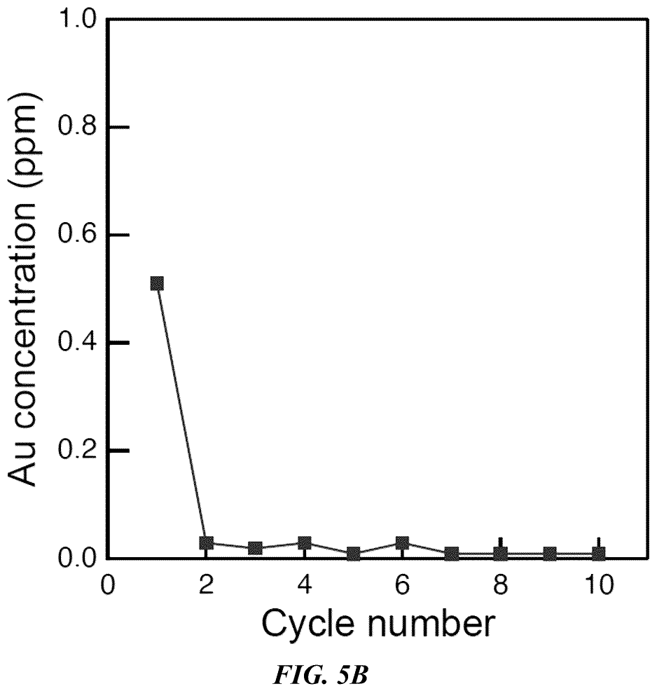

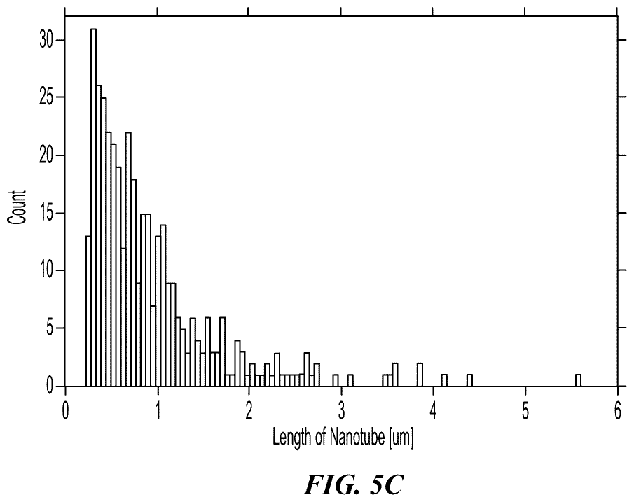

The AuNP-CysAA nanostructures may be homogeneously distributed in the solution due to their nanoscale structures and high surface area, as shown in FIG. 5A. That is, the ultraviolet-visible (UV-vis) spectrum of solution comprising the nanostructures 510 exhibits an absorbance spectrum indicative of AuNPs in solution. Additionally, utilizing the high-aspect-ratio morphology of the CysAA nanotubes (e.g., length of approximately 1 micron, diameter of approximately 30 nanometers), these AuNP-CysAA assemblies may be separated by a commercially available syringe filter with 0.22 micron holes. The UV-vis spectrum 520 confirm the solution passing through the filter does not contain any signal from AuNPs. Inductively coupled plasma (ICP) mass spectrometry analysis, shown in FIG. 5B, also confirms the solution does not contain detectable gold element. That is, FIG. 5B shows the amount of gold measured via ICP analysis as a function of cycle. A cycle includes passing solution containing CysAA through a filter, wherein the filtrate is analyzed by ICP analysis and the retentate is rehydrated to form a second solution. A second cycle would be performed on the second solution, where it is passed through a filter to obtain a filtrate for the ICP analysis. Substantially no gold was present in the filtrate after multiple cycles, showing the possibility of recycling and reusing the nanostructures (e.g., not wasting the nanostructures via filtration). Additionally, a plot showing the distribution of the Cys-AA nanotube length is shown in FIG. 5C, which indicates the majority of Cys-AA nanotubes have a length greater than the pore size of the filter used. This suggests the relatively large size (e.g., length) of the nanostructures prevents passage through the filter and facilitates the reuse.

The fact that (1) these AuNP-CysAA nanostructures may be evenly distributed (e.g., suspended) in the water to maximize the kinetics and mass transport to the catalysts in free solution (e.g., as opposed to mass transport at a two-dimensional surface as in heterogeneous catalysis), and (2) may be separated from the solution easily by filtration indicate the potential of using the AuNP-CysAA nanostructures as quasi-homogeneous catalysts that are suitable for industrial purposes.

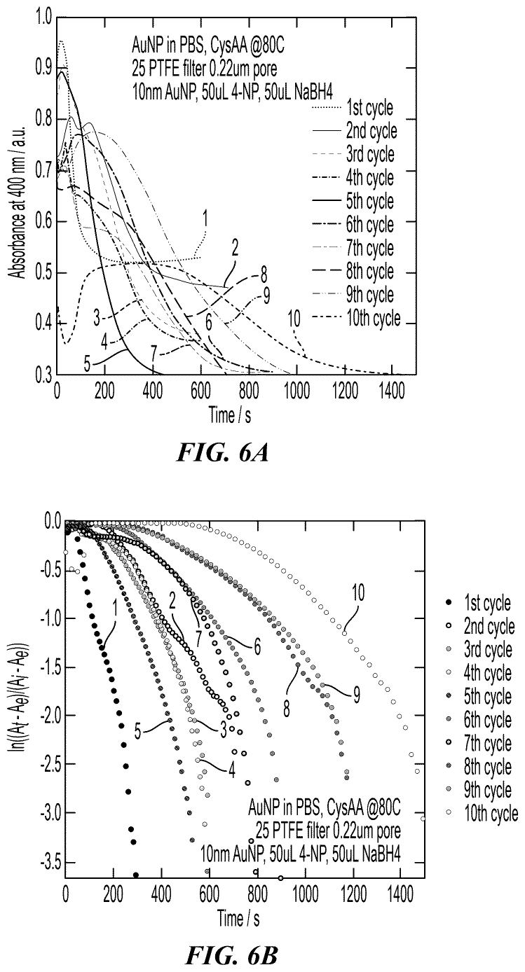

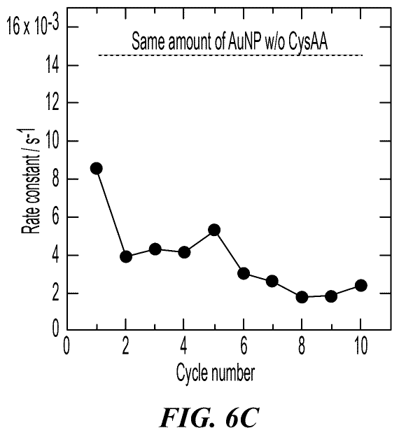

Finally, a demonstration of catalytic activity and cycling performance was performed using the reduction reaction of 4-nitrophenol (4-NP). 4-NP was chosen because the reaction kinetics may be quantified by monitoring the absorption intensity at 400 nm wavelength using UV-vis. FIG. 6A shows the kinetic profile of 4-NP reduction. After each reaction, the AuNP-CysAA nanostructures were separated from solution by simple filtering, then the AuNP-CysAA nanostructures were recovered in DI water with the same concentration to perform the next cycle measurement. FIG. 6A shows the catalytic activities of AuNP-CysAA are maintained after performing 10 cycles over weeks, strongly indicating the stability and reusability of the AuNP-CysAA nanostructures, which cannot be achieved by only AuNPs (e.g., in the absence of the CysAA nanotubes). FIG. 6B shows the dimensionless normalization of the kinetic profile in FIG. 6A, and FIG. 6C shows the corresponding reaction rate constant of each cycle extracted from FIG. 6B, assuming the reaction is a first-order reaction. Turnover frequency was also calculated based on the results from FIG. 6C and was calculated to be 21.5 s⁻⁴ for the first cycle and 6.0 s⁻¹ after 10 cycles, conservatively assuming the reaction completeness to be 80%. Note that, for most relevant industrial catalysts, the turnover frequency is in the range of 10⁻²-10² s⁻¹. Thus, the nanostructures in FIG. 6 show activity on the order of conventional industrial catalysts (e.g., heterogeneous catalysts). Additionally, note that the reason for the degrading reaction rate was most likely due to the loss of solution while transferring between vials to UV-vis cuvette, e.g., loss of catalyst between cycles. Therefore, these results demonstrate quasi-homogeneous, self-assembled nanotubes as support materials for high-performance molecular catalysts and sub-nm metal nanoparticle catalysts that are reusable.

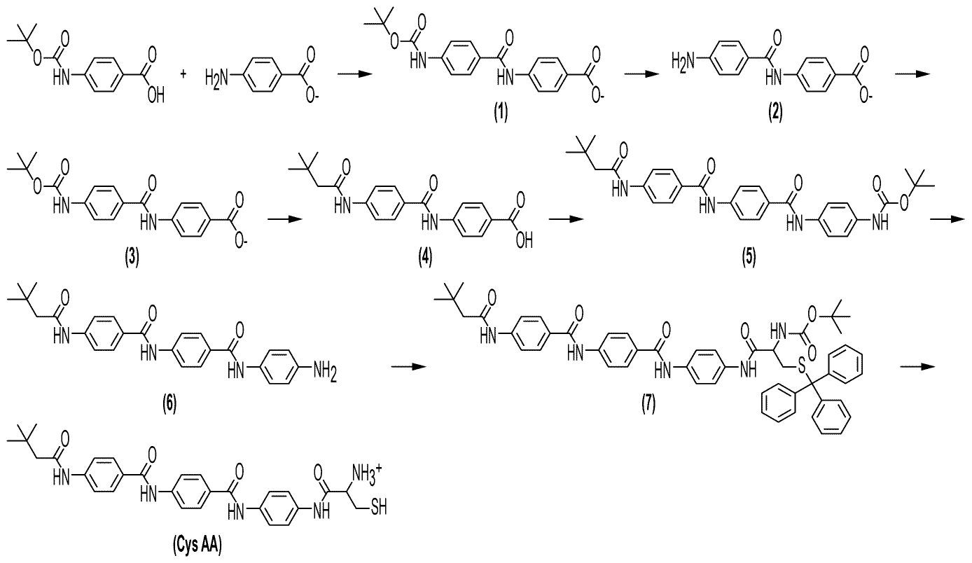

FIG. 7 shows an example synthesis procedure of the CysAA.

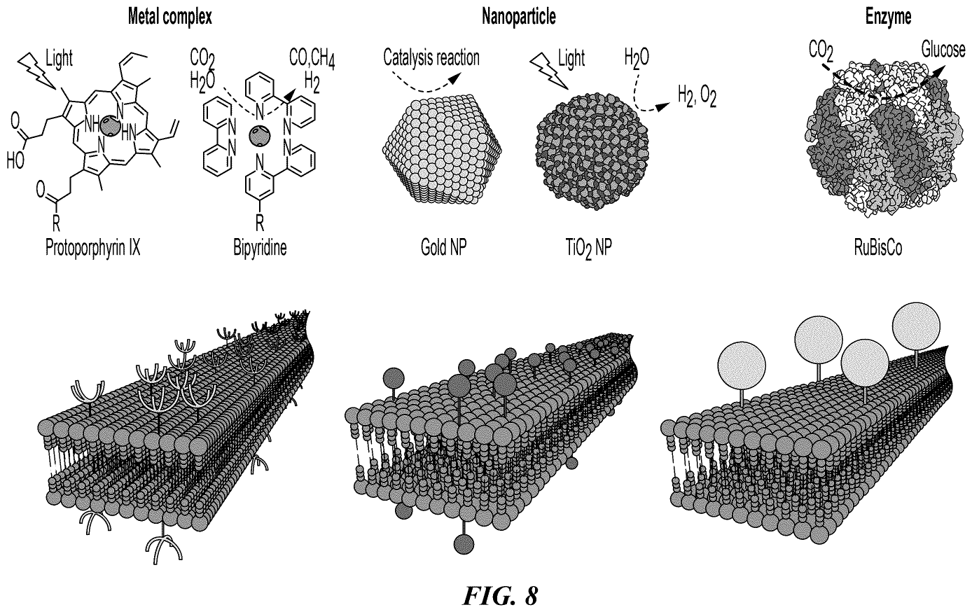

FIG. 8 shows some embodiments of the catalysts and enzymes that may be used to functionalize the AA self-assembled structures. As described elsewhere herein, by tuning the surface chemistry of the self-assembled structure comprising aramid amphiphiles, nanostructures comprising various function moieties (e.g., metal complexes, nanoparticles, and/or enzymes as shown in FIG. 8) may be formed. In some embodiments, functional (e.g., catalytic) moieties such as metal complex directly on the constituent molecules of the self-assembled structures, or other catalysts such as metal nanoparticles, metal oxide nanoparticles, and enzymes may be anchored on the surface of the self-assembled structures comprising aramid amphiphiles to form the nanostructures disclosed herein.

### Example 2

In this example, an example of synthesizing and using nanostructures for catalysis is described.

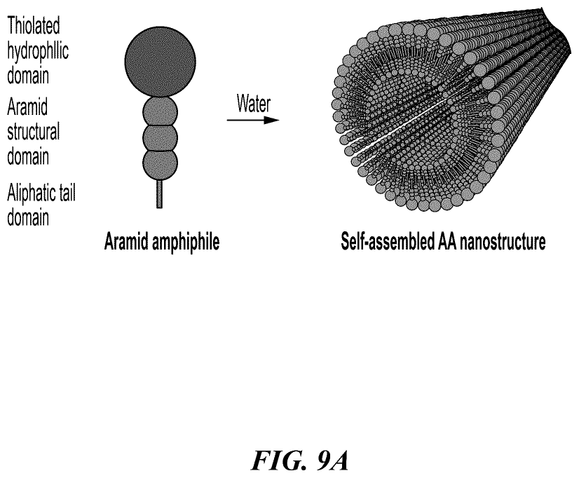

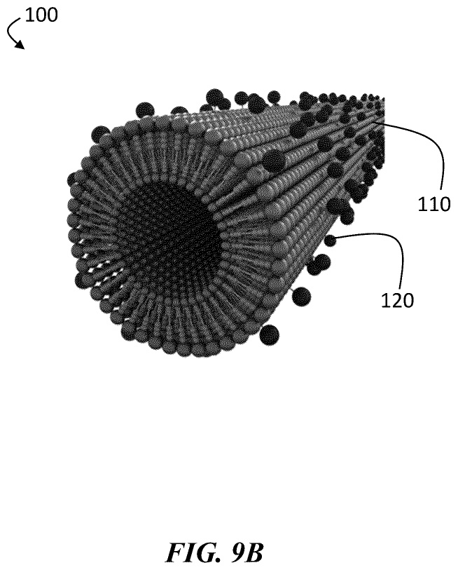

Self-assembled aramid amphiphiles (AA) nanotubes with thiolated surface chemistry, as shown in FIG. 9A, and nanometer-scale diameter gold nanoparticles (AuNPs) were used as the functional moiety of the nanostructure, as shown in FIG. 9B. The choice of AuNPs was based on the catalytic activity, technological readiness, and the ability to form gold-sulfur (Au—S) covalent bonds. The thiolation of the AA nanotubes was accomplished by synthetically modifying the hydrophilic domain of constituent AAs. By introducing the thiolated AA nanotubes into a suspension of AuNPs, the spontaneous formation of Au—S bonds between the nanotubes and AuNPs formed, as schematically illustrated in FIGS. 9A-9B. Specifically, aramid amphiphiles comprising cysteine self-assemble in water to form nanotubes, as shown in FIG. 9A. Adding a solution comprising AuNPs to the solution containing the nanotubes yields the nanostructures 100 shown in FIG. 9B comprising a self-assembled structure 110 containing aramid amphiphiles and having AuNPs as the functional moiety 120. The rigidity and resilience to mechanical fluctuations allow the AuNP-functionalized AA nanotubes to withstand the filtration process without fracturing or otherwise degrading. Accordingly, the nanostructures may be efficiently recovered from the filter, re-suspended in water, and reused in subsequent reactions.

By incorporating free N-terminal cysteine to the molecular design of AAs, AAs with thiol functional groups in their hydrophilic domain (CysAAs; FIG. 10A) were synthesized. Two control AAs were used to emphasize the importance of Au—S covalent bonding and rigid nanostructures for immobilizing the AuNPs and allowing the retention of the AuNP via filtration. The two control AAs used were: SerAAs, where the thiol group is substituted with a hydroxy group via the incorporation of free N-terminal serine; and CatAAs, which are AAs with a cationic triazaheptane hydrophilic domain that self-assemble into flexible nanoribbons (FIG. 10A). The molecular design of AAs also included an aliphatic tail domain with six-carbon neopentyl group, and aramid structural domain with three aramid repeating units, which were designed to promote self-assembly and enhance stability through strong intermolecular cohesion. Using conventional transmission electron microscopy (TEM), high-aspect-ratio, self-assembled nanotubes of CysAAs and SerAAs that were formed at an elevated temperature (e.g., greater than or equal to 80 degrees C.) were observed. In contrast, the self-assembly of CatAAs resulted in the formation of nanoribbons regardless of the temperature condition, consistent with previous reports.

Employing high-resolution Cryogenic TEM (cryo-TEM) further revealed that the CysAA and SerAA nanotubes possessed well-defined dimensions and have slightly different diameters. Based on cryo-TEM images, the exterior diameter of CysAA and SerAA nanotubes were 27.8 nm and 35.2 nm, respectively, with similar nanotube wall thicknesses of 3.7 nm and 3.5 nm, respectively (FIG. 10B). The contrast in geometry was also evident in the X-ray scattering patterns. Small angle X-ray scattering (SAXS) profiles of the CysAA and SerAA nanotubes, which correspond to the typical profile of a hollow cylinder, distinctly contrast with the lamellar bilayer profile obtained from the CatAA nanoribbons (FIG. 10C). By fitting the profiles with a hollow cylinder model, an exterior diameter of 29.4 nm and wall thickness of 5.7 nm for CysAA nanotubes and an exterior diameter of 34.7 nm and wall thickness of 5.9 nm for SerAA nanotubes were obtained. The measurements in FIG. 10C were consistent with the results from the cryo-TEM images of FIG. 10B.

The exterior diameter and wall thickness of nanotubes remain constant when holding the nanotube suspension at the elevated temperature during self-assembly. However, the average length of the nanotubes grows over time during self-assembly. Analyzed via TEM, statistical analysis was performed of TEM images collected of CysAA nanotubes that were heated for various amounts of time (FIG. 10D). The length distributions of CysAA nanotubes were found to follow a log-normal function of time. For example, extending the equilibration time (e.g., the time the AAs were heated and allowed to form nanotubes) from 12 hours to 24 hours to 72 hours, led to an increase in the average length of CysAA nanotubes from 0.09 microns to 0.45 microns to 0.73 microns, respectively.

An important feature of self-assembled AA nanostructure is their remarkable mechanical properties due to the strong intermolecular cohesion. For one-dimensional nanostructures, such as nanofibers, nanowires, and nanotubes, persistence length (P) is a typical mechanical parameter used to quantify the bending stiffness along the longitudinal direction. The persistence length of CysAA nanotubes was characterized using a statistical topographical analysis of atomic force microscope (AFM) images. After equilibrating the nanotubes in water on a glass surface, parametric splines to the counters were traced for over 60 individual CysAA nanotubes. A substantial persistence length of P=750±340 microns was determined through least-squares fitting to the midpoint deviations 6 of contour traces (FIG. 10E). That is, the persistence length was greater than or equal to 410 microns, greater than or equal to 750 microns, and/or less than or equal to 1090 microns. Although the persistence length is not an intrinsic parameter and depends on the cross-section dimensions, the millimeter-scale order of magnitude observed here is significantly higher than those reported for conventional one-dimensional nanomaterials comprising small molecules such as amyloid fibrils and organic nanotubes.

Additionally, since the diameter of CysAA nanotubes is slightly larger than the tips of AFM, force-displacement curves were directly measured at the center of the nanotube to evaluate stiffness along the transverse direction of the nanotube. The CysAA nanotubes remained intact up to 10 nN of transverse loading and approximately 10% of transverse strain (FIG. 10F). Furthermore, the good overlapping observed between the approach and retraction curves confirmed that the hysteresis of the measurement was low and indicates that the nanotubes may restore most of their elastic energy upon release of the load. The stiffness of the nanotubes was calculated from the linear slopes of the approach curves, which resulted in a median value of 3 N/m for CysAA nanotubes. This stiffness is significantly greater than that of conventional, biomimetic tubes, which typically exhibit stiffness on the order of 0.01 N/m, and thus demonstrating the rigidity of the AA nanotubes.

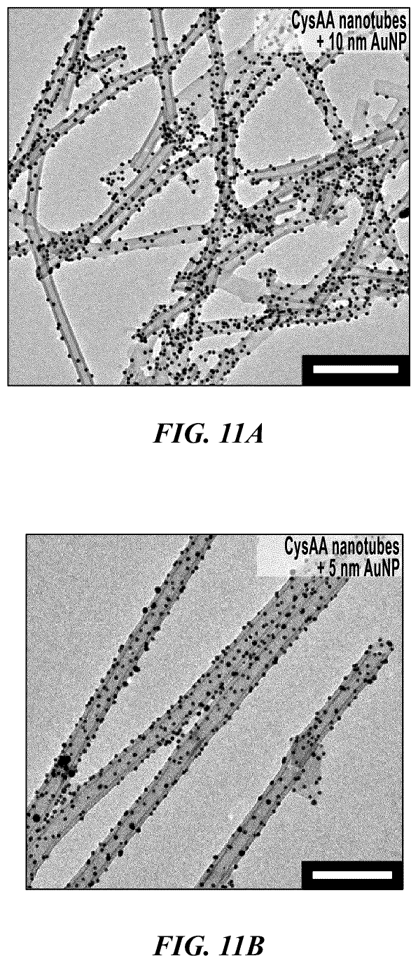

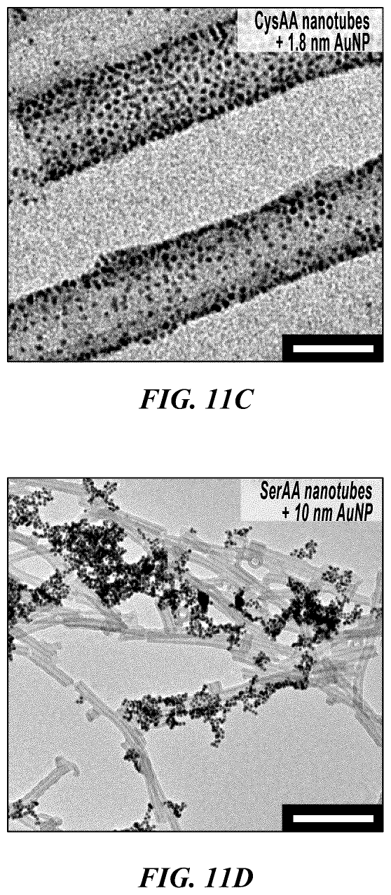

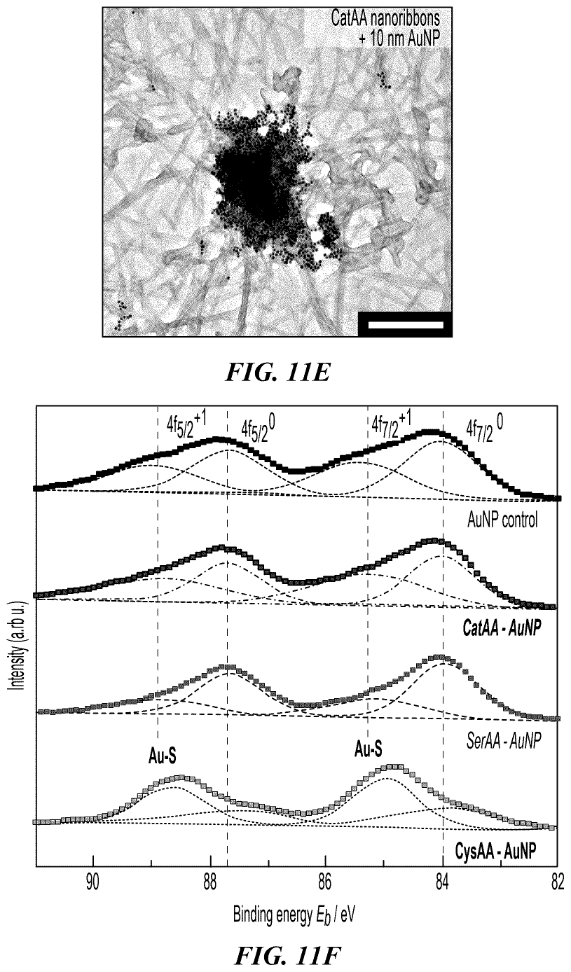

CysAA nanotubes were then mixed with AuNPs having an average diameter of approximately 10 nm. The AuNPs were evenly distributed and anchored on the surface of CysAA nanotubes (FIG. 11A). By adjusting the ratio of nanotubes to AuNPs in the suspension, the loading ratio of AuNPs on CysAA nanotubes may be easily tuned. An advantage of the present method is that the AuNPs are synthesized separately to the introduction to the self-assembled CysAA structure to form the nanostructures. This avoids any issues involved with timing sensitive approaches wherein the metal nanoparticles are synthesized directly on a support material, for example, a seed mediated method wherein the seeds are present on the support material. Moreover, CysAA nanotubes can be functionalized with AuNPs of any size with relatively homogeneous size dispersity, such as 5 nm and 1.8 nm, because the nanoparticles may be synthesized by conventional, controlled, solution-based methods (FIGS. 11B-11C).

In contrast to the nanostructures comprising CysAA shown in FIGS. 11A-11C, when the two control AA nanostructures, SerAA nanotubes and CatAA nanoribbons, were mixed with AuNPs, the nanoparticles aggregated (FIGS. 11D-11E). Although the surface chemistries of these control AA nanostructures were also expected to interact electrostatically with AuNPs, the results show that the thiol functional group of the cysteine is important for the immobilization of AuNPs on AA nanostructure. To further verify the Au—S covalent bonding in AuNPs functionalized CysAA nanotubes, X-ray photoelectron spectroscopy (XPS) was carried out. FIG. 11F exhibits the Au4f XPS spectrum of dried, AuNP-functionalized CysAA nanotubes, and shows the distinct chemical states of Au compared to the control of AuNPs dried directly. The majority of Au4f peaks for AuNP-functionalized CysAA nanotubes were identified as the Au—S covalent bond. In contrast, the control nanostructures of SerAA and CatAA display spectra that are near-identical to that of the AuNP control, corroborating with the observation of aggregation seen in TEM images (e.g., FIGS. 11D-11E).

Lastly, AuNP-functionalized CysAA nanotubes were used as catalysts, retained by microfiltration of the solution, and then reused as catalysts, demonstrating the ability to reuse the robust nanostructures comprising CysAA. This is advantageous because the 10 nm AuNPs cannot be separated from solution by commonly available filters, and thus the nanostructures comprising high-aspect-ratio CysAA nanotubes (e.g., having lengths of approximately 1 micron and diameters of approximately 30 nanometers) facilitates the retention, and thus reusability, of the AuNPs (e.g., on the Cys-AA nanostructures) using commercially available filtration systems, such as those with 0.2 micron pore sizes (FIG. 12A). Once the solution passed through the filter, the nanotubes were recovered into a new suspension by backwashing the filter with water. The filtrate was colorless, and the UV-visible (UV-vis) spectrum of the filtrate did not show any absorption from AuNPs. Inductively coupled plasma (ICP) analysis was also performed to quantitatively determine the amount of AuNPs that passed through the filter. Beside the initial filtrate, which exhibited about 0.5 ppm of gold, the filtrate did not contain a detectable level of gold, even after 10 recover cycles (e.g., filtering of and reintroducing of the nanotubes to solution).

To demonstrate the catalytic activity and reusability, the AuNP-functionalized CysAA nanotubes were used to catalyze the reduction reaction of 4-nitrophenol (4-NP) to 4-aminophenol (4-AP) with sodium borohydride (NaBH4). This reaction was selected because its kinetics may be quantified by monitoring the absorption intensity at the wavelength of 400 nm using UV-vis spectroscopy (FIG. 12B). The time dependence of absorbance at 400 nm remains consistent for the first three cycles, in which the CysAA supported AuNPs with a diameter of 10 nm are separated from the reacted solution by filtration, recovered in fresh water, and reused in subsequent reactions (FIG. 12C). By normalizing the time dependence of absorbance, a first-order plot can be obtained, from which a rate constant can be extracted. Compared to an equivalent amount of AuNP control, the rate constant for AuNP-functionalized CysAA decreased by about half of the initial rate constant after being recycled (FIG. 12D). This is not unexpected, as the surface-to-volume ratio of the AuNPs decreases following immobilization in the nanostructures (e.g., immobilized on the CysAA). Nevertheless, the catalytic activities of AuNP-functionalized CysAA nanotubes are maintained after performing 10 cycles over several weeks (FIG. 12D). Post these cycles, the nanostructures of the AuNP-functionalized CysAA nanotubes remained intact.

The turnover frequency (TOF), calculated based on the known particle concentration of AuNPs, yields 21.5 s⁻¹ for the first cycle and 6.0 s⁻¹ after 10 cycles, conservatively assuming the reaction completeness to be 80%, as shown in FIG. 12D. Again, these TOFs are comparable to those of catalysts used in industrial applications, which typically range from 10⁻² s⁻¹-10² s⁻¹. This decrease is likely attributable to a combination of factors: 1) a partial reaction between NaBH₄ and CysAA nanotubes, 2) the adherence of the nanotubes to the filter materials, and 3) an inevitable loss of solution during transfer. Particularly for the partial reaction between the NaBH₄ and CysAA nanotubes, a consistent loss of about 1 to 2 ppm of gold was detected in the filtrate by ICP analysis. Additionally, it was found that shorter AuNP-functionalized CysAA nanotubes were able to pass through the filter in the later cycles, which further compounded the decreasing rate constants observed in FIG. 12D due to loss of catalytic material. The fact that these AuNP-functionalized CysAA nanotubes may both distribute evenly in water (e.g., maximizing the kinetics of the catalytic reaction and the mass transport to each nanostructure) and may be easily separated from solution by filtration show the possible industrial applicability of the quasi-homogeneous catalysts.

The results demonstrate a new method to enhance the retention capability of nanocatalysts by tethering them to nanostructures comprising small molecules (e.g., AAs). The CysAA, tailored for this purpose, self-assembles into high-aspect-ratio, rigid nanotubes with well-defined dimensions. The thiolated surface chemistry of these nanotubes allows for the successful immobilization of AuNPs. Owing to their substantial persistence length and high stiffness, these CysAA nanotubes can withstand mechanical fluctuation without breaking during filtration process. The resulting AuNP-functionalized CysAA nanotubes demonstrate high catalytic activity for the reduction reaction of 4-NP, maintaining performance across ten cycles of recovery and reuse. With an estimated TOF of 21.5 s⁻¹ for the first cycle and 6.0 s⁻¹ after 10 cycles, these rates are comparable to conventional catalysts used in industrial applications.

### Example 3

The following example describes separating of the nanostructures from solution.

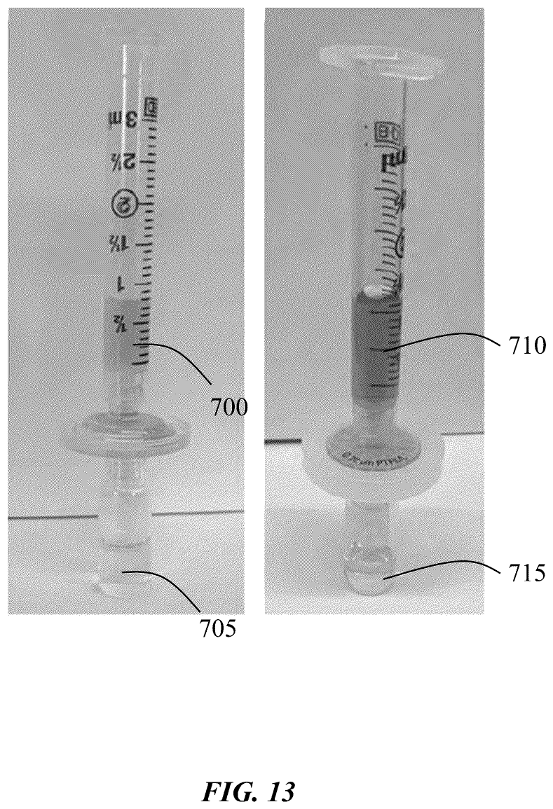

As described elsewhere herein, the relatively high aspect ratio of the nanostructures facilitates the separation and reuse of the nanostructures. FIG. 13 shows the filtration of a first solution 700 comprising AuNPs and a second solution 710 comprising Cys-AA nanostructures. Optically, the filtrate 715 of the second solution 710 appeared to be clear and no longer contain significant amounts of the Cys-AA nanostructures, wherein the filtrate 705 of the first solution 70 maintained a color associated with the AuNPs in solution.

The solution comprising the CysAA was passed through a syringe filter for 10 cycles (e.g., passed through the filter, wherein the retained CysAA nanostructures were rehydrated, then the solution comprising the CysAA was passed through a second syringe filter for a second cycle, and so forth). The amount of gold in the filtrate, e.g., the solution that passed through the solution, was then quantified using ICP analysis. The results in Table 1 show these results and highlight that little to no gold is present in the solution after passing through the filter. This shows the CysAA structures may be separated from solution and reused.

TABLE 1
Gold in filtrate solution as a function of cycle.

| Cycle number | AuNP concentration (ppm) |
|---|---|
| 1 | 0.01 |
| 2 | 0.03 |
| 3 | 0.02 |
| 4 | 0.03 |
| 5 | 0.51 |
| 6 | 0.03 |
| 7 | 0.01 |
| 8 | 0.01 |
| 9 | 0.01 |
| 10 | 0.01 |

In addition, the filter membrane material and pore size were tested for separating CysAA. Specifically, filters comprising polyethersulfone (PES), polyvinylidene fluoride (PVDF), and polytetrafluoroethylene (PTFE) having variable pore sizes and diameters were used. The results are shown in Table 2.

TABLE 2
Results of filtering CysAA nanostructures
as a function of filter parameters.

| Filter | Diameter | Pore size | Retains | Sticks to |
|---|---|---|---|---|
| Material | (mm) | (microns) | CysAA | CysAA? |
| PES | 25 | 0.45 | No | Yes |
| PES | 25 | 0.2 | Yes | Yes |
| PES | 13 | 0.2 | Yes | Yes |
| PVDF | 13 | 0.22 | No | Yes |
| PTFE | 13 | 0.22 | Yes | No |
| PTFE | 25 | 0.22 | Yes | No |

The results show filters having relatively small pores and being made of PTFE were most effective for separating CysAA nanostructures from solution without the CysAA nanostructures sticking to the filter media.

It should be understood that the subject matter defined in the appended claims is not necessarily limited to the specific implementations described above. The specific implementations described above are disclosed as examples only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A nanostructure, comprising:
an aramid amphiphile; and
a functional moiety associated with the aramid amphiphile,
wherein the functional moiety is configured to catalyze a chemical reaction.

2. The nanostructure of claim 1, wherein the functional moiety is chemically bound to the aramid amphiphile.

3. The nanostructure of claim 1, wherein the functional moiety is covalently bound to the aramid amphiphile.

4. The nanostructure of claim 1, wherein the functional moiety comprises a nanoparticle, an enzyme, and/or a metal complex.

5. (canceled)

6. The nanostructure of claim 1, wherein the aramid amphiphile comprises a cysteine group.

7. The nanostructure of claim 6, wherein the cysteine group is charged.

8. The nanostructure of claim 6, wherein the cysteine group is chemically bonded to the functional moiety.

9. The nanostructure of claim 1, wherein the aramid amphiphile comprises an amino acid, amino acid derivative, and/or peptide.

10. (canceled)

11. The nanostructure of claim 10, wherein the plurality of aramid amphiphiles is arranged as a nanoribbon and/or a nanotube.

12. (canceled)

13. The nanostructure of claim 11, wherein the nanoribbon and/or the nanotube have an aspect ratio of at least 1:25.

14. The nanostructure of claim 10, wherein the nanostructure comprises a plurality of functional moieties, wherein each of the functional moieties is covalently bound to at least one aramid amphiphile of the plurality of aramid amphiphiles.

15-19. (canceled)

20. A composition, comprising:
a solution or suspension;
the nanostructure of claim 1 in the solution or suspension; and
a reactant in the solution or suspension,
wherein the functional moiety of the nanostructures is configured to homogeneously catalyze the reactant to a product.

21. A method of making the nanostructure of claim 1, comprising:
providing a first solution or suspension comprising the aramid amphiphile of the nanostructure; and
mixing the first solution or suspension with a second solution or suspension comprising the functional moiety of the nanostructure.

22. A method of using the nanostructure of claim 1 to catalyze a chemical reaction, comprising:
providing the nanostructure in a solution or suspension; and
catalyzing, with the nanostructure, a conversion of a reactant to a product in the solution or suspension.

23. A method of using the nanostructure of claim 1 to catalyze a chemical reaction, comprising:
converting a reactant to a product in a solution or suspension, the solution or suspension comprising the nanostructure; and
separating the nanostructure from the solution or suspension.

24-33. (canceled)

34. A nanostructure comprising
a. an aramid amphiphile of claim 1, comprising a charged cysteine group;
b. a functional moiety selected from the group consisting of a nanoparticle, an enzyme, and a metal complex;
wherein the functional moiety is covalently bound to the aramid amphiphile through the cysteine.

35. The nanostructure of claim 1, comprising a molecule having the structure of Cys

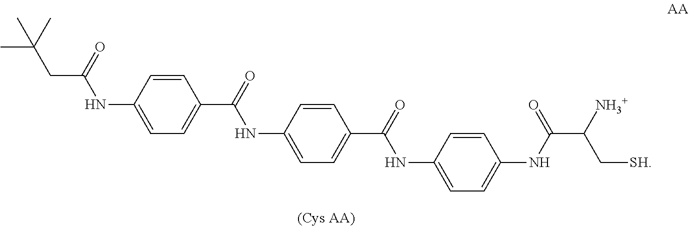

36-39. (canceled)

40. The nanostructure of claim 34, wherein the aramid amphiphile is self-assembled into a nanotube.

41. The nanostructure of claim 34, wherein the aramid amphiphile is self-assembled into a nanoribbon.

42. (canceled)

43. A method of use of the nanostructure of claim 34 to catalyze a chemical reaction, comprising
a. preparing a reactant;
b. combining the reactant with the nanostructure in a solution;
c. converting the reactant to a product in the solution;
d. separating the nanostructure from the solution; and
e. restoring the catalytic activity of the nanostructure by rinsing in an aqueous solution water.

44. (canceled)
